(19) United States
(12) Patent Application Publication
(10) Pub. No.: US 2015/0002256 A1
(43) Pub. Date: Jan. 1, 2015

(54) DEVICES AND METHODS RELATED TO LAMINATED POLYMERIC PLANAR MAGNETICS

(71) Applicant: BOURNS, INC., Riverside, CA (US)

(72) Inventors: Gordon L. BOURNS, Riverside, CA (US); John KELLY, Passage West (IE); Andy CHOW, Cerritos, CA (US); Chi-Hao KU, New Taipei City (TW); Erik MEIJER, Orange, CA (US)

(21) Appl. No.: 14/205,322

(22) Filed: Mar. 11, 2014

Related U.S. Application Data
(60) Provisional application No. 61/776,589, filed on Mar. 11, 2013.

(51) Int. Cl. H01F 27/28; H01F 41/04; H01F 27/29

(52) U.S. Cl. CPC H01F 27/2804; H01F 27/29; H01F 41/041; H01F 2027/2809
USPC 336/84 M; 336/200; 336/192; 29/602.1; 29/593

(57) ABSTRACT

Disclosed are devices and methods related to laminated polymeric planar magnetics. In some embodiments, a magnetic device can have a base layer including a polymeric laminate layer. The base layer can further include a set of one or more conductive ribbons implemented on a first side of the polymeric laminate layer. The base layer can have a perimeter that includes at least one cut edge. The magnetic device can further include a structure implemented on the base layer. The structure can include a set of one or more conductor features implemented on a side away from the base layer. The structure can have a perimeter that includes an edge set inward from the cut edge by an amount sufficient to allow a cutting operation that cuts the polymeric laminate layer to yield the cut edge.

### CROSS-REFERENCE TO RELATED APPLICATIONS

This application claims priority to U.S. Provisional Application No. 61/776,589 filed Mar. 11, 2013 entitled DEVICES AND METHODS RELATED TO LAMINATED POLYMERIC PLANAR MAGNETICS, the disclosure of which is hereby expressly incorporated by reference herein in its entirety.

### BACKGROUND

1. Field

The present disclosure generally relates to magnetics, and more particularly, to devices and methods related to laminated polymeric planar magnetics.

2. Description of the Related Art

Traditional magnetic devices such as inductors, transformers and chokes typically include conductive wires wrapped around magnetic cores. Such magnetic devices can be implemented in a wide range of electrical and/or magnetic applications.

In many of the foregoing applications, magnetic devices need to be mounted on circuit boards such as printed circuit boards (PCBs). With many traditional through-hole magnetic devices, such mounting on PCBs can be time-consuming and unreliable.

### SUMMARY

In some implementations, the present disclosure relates to a magnetic device having a base layer that includes a polymeric laminate layer. The base layer further includes a set of one or more conductive ribbons implemented on a first side of the polymeric laminate layer. The base layer has a perimeter that includes at least one cut edge. The magnetic device further includes a structure implemented on the base layer. The structure includes a set of one or more conductor features implemented on a side away from the base layer.

In some embodiments, the structure can have a perimeter that includes an edge set inward from the cut edge by an amount sufficient to allow a cutting operation that cuts the polymeric laminate layer to yield the cut edge. In some embodiments, the polymeric laminate layer can include a magnetic polymer material.

In some embodiments, the structure can include a magnetic polymer material. The magnetic polymer structure can be formed on the base layer. The magnetic polymer structure can be printed or molded on the base layer.

In some embodiments, the magnetic polymer structure can be attached to the base layer by, for example, a layer of adhesive and/or one or more anchor pins that extend through at least portions of vias formed on the magnetic polymer structure and the base layer.

In some embodiments, the set of one or more conductive ribbons can include a spiral shaped ribbon having an outer end and an inner end. The base layer can further include a conductive via in electrical contact with the inner end of the spiral shaped ribbon. The conductive via can be configured to provide an electrical connection between the inner end of the spiral shaped ribbon to a location of the ribbon on a second side opposite the first side of the base layer.

In some embodiments, the set of one or more conductive ribbons can include a plurality of strips arranged in a generally parallel manner. The base layer can further include a plurality of conductive vias in electrical contact with corresponding ends of the strips. The conductive vias can be configured to provide electrical connections between the corresponding ends of the strips to locations on a second side opposite the first side of the base layer.

In some embodiments, the set of one or more conductor features can include a second set of one or more conductive ribbons. The second set of one or more conductive ribbons can include a spiral shaped ribbon having an outer end and an inner end. The second set of one or more conductive ribbons can include a plurality of strips arranged in a generally parallel manner.

In some embodiments, the magnetic device can further include an insulator layer formed over the second set of one or more conductive ribbons. The magnetic device can further include a plurality of terminals formed over the insulator layer, with at least one of the terminals being in electrical contact with the first set of one or more conductive ribbons and at least one other terminal in electrical contact with the second set of one or more conductive ribbons.

In some embodiments, the set of one or more conductor features can be formed substantially directly on the magnetic polymer material. In some embodiments, the set of one or more conductor features can include one or more terminals formed substantially directly on the magnetic polymer material.

In some embodiments, the structure can be implemented on the first side of the base layer. The magnetic device can further include a second structure implemented on a second side of the base layer. The second structure can have a perimeter that includes an edge set inward from the cut edge by an amount sufficient to allow the cutting operation that yields the cut edge of the base layer.

In some implementations, the present disclosure relates to a method for manufacturing magnetic devices. The method includes forming or providing a base layer that includes a polymeric laminate layer. The base layer further includes an array of a set of one or more conductive ribbons implemented on a first side of the polymeric laminate layer. The method further includes forming or providing an array of structures on the base layer. The method further includes forming a set of one or more conductor features over each structure, with at least some of the one or more conductor features being electrically connected to the set of one or more conductive ribbons. The method further includes cutting the polymeric laminate layer to yield a plurality of individual units, with each of the individual units having a structure implemented on the base layer.

In some embodiments, either or both of the polymeric laminate layer and the array of structures can include magnetic polymer material. In some embodiments, the cutting of the polymeric laminate layer can include cutting the array of structures.

In some embodiments, the array of structures can be configured to define open spaces between the structures, and the open spaces can be sufficiently large such that the cutting of the polymeric laminate layer is achieved without the structures being touched by a cutting tool. In some embodiments, the method can further include forming conductive vias to yield the electrical connection between the conductive ribbons and the conductor features. The conductor features can include terminals. The forming of the terminals can include forming a conductor layer, and etching the conductor layer with a pattern to yield the terminals. In some embodiments, the method can further include forming an insulator layer over the structure prior to the forming of the conductor layer.

In some embodiments, the forming of the conductive vias can include forming castellation vias through the polymeric laminate layer. The castellation vias can be dimensioned to yield castellation features on at least one side of each structure. The forming of the conductive vias can further include plating the castellation vias.

In some embodiments, the method can further include forming a second set of one or more conductive ribbons on the structure.

In some implementations, the present disclosure relates to a magnetic device that includes a polymeric laminate layer having a first side and a second side opposite the first side. The magnetic device further includes a first set of one or more conductive ribbons disposed on the first side of the polymeric laminate layer. The magnetic device further includes a set of one or more conductive vias that extend through the polymeric laminate layer and connected to the first set of conductive ribbons so as to provide an electrical connection between the first set of conductive ribbons and one or more locations on the second side of the polymeric laminate layer.

In some embodiments, the magnetic device can further include a second set of one or more conductive ribbons disposed on the second side of the polymeric laminate layer. The set of one or more conductive vias can electrically connect the first and second sets of conductive ribbons to yield a winding. Each of the first and second sets of conductive ribbons can include a plurality of strip ribbons arranged in a generally parallel manner so as to yield a magnetic flux axis that is generally parallel to a plane of the polymeric laminate layer when a current flows through the winding. Each of the first and second sets of conductive ribbons can include a spiral shaped ribbon. The first and second spiral shaped ribbons can be electrically connected so as to yield a magnetic flux axis that is generally perpendicular to a plane of the polymeric laminate layer when a current flows through the winding.

In some embodiments, the polymeric laminate layer can include a magnetic material configured to provide a magnetic core for the winding. In some embodiments, the winding can include an input terminal and an output terminal so as to yield a planar inductor having an inductance value.

In some embodiments, the magnetic device can further include a second winding. The first and second windings can be configured and positioned relative to each other so as to yield a transformer. The first and second windings can be formed on a common polymeric laminate layer. The first and second windings can be formed on separate polymeric laminate layers. In some embodiments, the polymeric laminate layers associated with the first and second windings can be arranged in a stack. In some embodiments, the first and second windings can be arranged in a nested configuration.

In some embodiments, each of the first winding and the second winding can be configured as a planar inductor having an inductance value. In some embodiments, the first winding and the second winding can be configured and positioned relative to each other so as to yield a transformer. The first and second magnetic flux axes associated with the first and second windings can be generally co-planar. The first and second magnetic flux axes can be generally co-axial. The first and second magnetic flux axes can be generally parallel but separated by a distance.

In some embodiments, the magnetic device can further include one or more packaging layers disposed on one or more of the first and second sides of the polymeric laminate layer. The packaging layer can include one or more electrical terminals connected to one or more terminals of the winding. The packaging layer can be configured to provide magnetic shielding.

In some implementations, the present disclosure relates to a method for manufacturing magnetic devices. The method includes forming or providing a polymeric laminate layer having a first side and a second side opposite the first side. The polymeric laminate layer includes a plurality of regions, with each region configured to be separable into an individual unit. The method further includes forming a first set of one or more conductive ribbons on the first side of each region of the polymeric laminate layer. The method further includes forming a set of one or more conductive vias that extend through each region of the polymeric laminate layer, such that the set of one or more conductive vias are connected to the first set of conductive ribbons so as to provide an electrical connection between the first set of conductive ribbons and one or more locations on the second side of the polymeric laminate layer.

In some embodiments, the method can further include forming a second set of one or more conductive ribbons disposed on the second side of each region of the polymeric laminate layer, such that the set of one or more conductive vias electrically connecting the first and second sets of conductive ribbons to yield a winding. In some embodiments, the method can further include forming a plurality of terminals for the winding. In some embodiments, the method can further include performing one or more tests by making electrical contact with the terminals of the winding while the polymeric laminate layer remains un-singulated.

In some embodiments, the method can further include singulating the polymeric laminate layer so as to yield a plurality of individual magnetic devices corresponding to the plurality of regions. In some embodiments, the method can further include combining the individual magnetic device with a non-magnetic device to yield an integrated component package. In some embodiments, the method can further include coupling a non-magnetic device to each of the un-singulated individual unit.

In some implementations, the present disclosure relates to a surface-mountable magnetic device having a first planar component including a polymeric laminate layer having a first side and a second side. The first planar component further includes one or more conductive patterns implemented on either or both of the first and second sides of the polymeric laminate layer so as to provide a planar magnetic functionality. The surface-mountable magnetic device further includes a second planar component coupled to the first side of the first planar component. The second planar component includes a plurality of terminals configured to allow surface-mounting of the magnetic device. The surface-mountable magnetic device further includes a plurality of connection features implemented to provide electrical connections between the one or more conductive patterns and the plurality of terminals.

In some embodiments, the polymeric laminate layer of the first planar component can include a perimeter having at least one cut edge resulting from a singulation process that yields the surface-mountable magnetic device as one of a plurality of similar devices. The plurality of similar devices can be at least partially fabricated in an array before the singulation process.

In some embodiments, the surface-mountable magnetic device can further include a third planar component coupled to the second side of the first planar component. The third planar component can include a plurality of terminals electrically connected to the one or more conductive patterns. The third planar component and its terminals can be configured to allow surface-mounting of the magnetic device. In some embodiments, the terminals of the second planar component and the third planar component can be configured to provide either or both of end-to-end and top-to-bottom connection symmetry.

In some embodiments, the second planar component can include a packaging layer configured to provide packaging functionality between the first planar component and the plurality of terminals.

In some embodiments, the second planar component can include a planar structure formed from a magnetic polymer material. The planar structure can include a perimeter that includes an edge set inward from the cut edge of the polymeric laminate layer of the first planar component by an amount sufficient to allow a cutting operation that cuts the polymeric laminate layer. The surface-mountable magnetic device can further include a third planar component having a planar structure formed from a magnetic polymer material.

In some embodiments, the terminals of the second planar component can be patterned from a conductive layer formed on an outer surface of the planar structure. In some embodiments, the second planar component can further include a conductor pattern formed on an outer surface of the planar structure. The second planar component can further include an insulator layer that substantially covers the conductor pattern formed on the outer surface of the planar structure. The terminals of the second planar component can be patterned from a conductive layer formed on an outer surface of the insulator layer.

In some embodiments, either or both of the first planar component and the second planar component can include magnetic material. In some embodiments, the plurality of connection features can include one or more conductive vias.

In some embodiments, the surface-mountable magnetic device can further include a non-magnetic device coupled to the magnetic device so as to retain the surface-mountable functionality. The magnetic device and the non-magnetic device can be arranged in a stack configuration, side-to-side configuration, or end-to-end configuration. The magnetic device and the non-magnetic device can be combined as an integrated component package.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows a laminate layer based device having one or more inductive elements.

FIG. 2 shows that in some embodiments, a laminate layer based device having one or more inductive elements can also include one or more magnetic materials.

FIG. 3 shows that in some embodiments, the laminate device of FIG. 1 and/or FIG. 2 can be implemented as a magnetic component.

FIG. 4 shows that devices having one or more features as described herein can be implemented as a packaged device.

FIG. 5 shows an example of a laminate device having a plurality of conductor features that can be configured to yield an inductive element.

FIG. 6 shows an example where conductive ribbons are formed on one side of a laminate layer.

FIG. 7 shows an example where conductive ribbons are formed on both sides of a laminate layer.

FIGS. 8A and 8B show that in some implementations, devices having one or more features as described herein can be fabricated as an array.

FIGS. 9A-9D show an example of how conductive features such as conductive ribbons and vias can be formed on and through a laminate layer.

FIGS. 10A-10E show another example of how conductive features such as conductive ribbons and vias can be formed on and through a laminate layer.

FIGS. 11A and 11B show example configurations where first and second windings can be arranged so that their respective axes of magnetic fluxes are generally co-axial but offset longitudinally.

FIGS. 12A and 12B show example configurations where first and second windings can be arranged so that their respective axes of magnetic fluxes are generally parallel but offset laterally.

FIG. 12C shows a perspective view of an example configuration of an assembly that is similar to the example of FIG. 12B.

FIG. 13 shows an exploded view of an example assembly where first and second windings can be positioned in different planes.

FIG. 14A shows an exploded view of an example assembly that includes one winding nested within another winding, and FIGS. 14B-14E show various stages of an example fabrication process for such an assembly.

FIG. 15 shows a configuration where a conductive ribbon formed on a laminate substrate has a spiral shape.

FIGS. 16A and 16B show how two windings can be connected so that currents flowing through them generate magnetic fields that enhance each other.

FIG. 17 shows an exploded view of an example assembly having two separate laminate layers each having one or more spiral ribbons.

FIGS. 18A and 18B show laminate substrates each having more than one spiral ribbon, where such laminate substrates can be utilized individually or in combination.

FIG. 19 shows an exploded view of an example assembly where one or more devices having ribbon strips can be stacked together with one or more ribbon spirals.

FIGS. 20A and 20B show a configuration where a laminate layer is formed from a magnetic material.

FIGS. 21A and 21B show a configuration where magnetic material partially occupies the overall laminate device.

FIGS. 22A-22D show an example of how the laminate device of FIGS. 21A and 21B can be fabricated.

FIGS. 23A and 23B show an example of how the partial-magnetic region configuration of FIGS. 21 and 22 can be varied.

FIGS. 24A-24F show an example of how the laminate device of FIGS. 23A and 23B can be fabricated.

FIGS. 25A and 25B show side and plan views of a packaged device having a planar magnetic device.

FIGS. 26A-26C show examples of electrical contact features that can be implemented on a given packaging layer.

FIG. 27 shows a plan view of an example configuration where a stack of layers defines an array of individual devices.

FIG. 28 shows a side sectional view of the example configuration of FIG. 27.

FIG. 29 shows that in some embodiments, one or more layers in a stack can be dimensioned to reduce the amount of materials through which singulating cuts are made.

FIG. 30 shows an example of a base layer on which structures can be implemented.

FIG. 31 shows another example of a base layer on which structures can be implemented.

FIG. 32 shows a process that can be implemented to fabricate planar magnetic devices based on the example base layer and structures of FIGS. 29-31

FIG. 33 shows examples of various stages of fabrication generally corresponding to various steps of the process of FIG. 32.

FIG. 34 shows another process that can be implemented to fabricate planar magnetic devices based on the example base layer and structures described in reference to FIGS. 29-31.

FIG. 35 shows examples of various stages of fabrication generally corresponding to various steps of the process FIG. 34.

FIGS. 36A-36C show examples of how magnetic polymer structures can be implemented on a base layer.

FIG. 37 shows that in some embodiments, more than one layer of structures can be formed or provided on a base layer.

FIG. 38 shows a configuration where an additional layer can be implemented on one side of a base layer.

### DETAILED DESCRIPTION OF SOME EMBODIMENTS

The headings provided herein, if any, are for convenience only and do not necessarily affect the scope or meaning of the claimed invention.

Magnetic components such as inductors, transformers and chokes often have magnetic cores around which wire is wrapped. In some embodiments, planar technologies can be utilized to fabricate devices such as ceramic inductors, non-ceramic inductors, transformers and chokes.

Described herein are various examples of devices and methods related to magnetic components that can be based on laminate technologies. Such components can include, for example, inductors, transformers and chokes mountable on printed circuit boards (PCB's). Advantages of utilizing these technologies can include improved electrical performance, reduced PCB space requirements, higher quality, better long-term reliability and lower manufacturing costs.

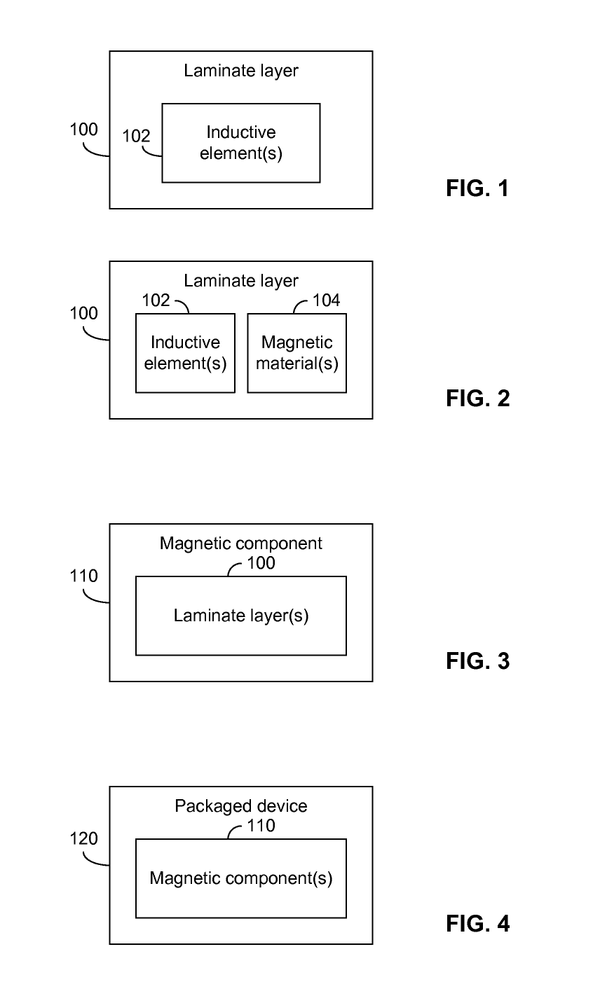

FIG. 1 schematically depicts a polymeric laminate layer based device 100 having one or more inductive elements 102. As described herein, such an inductive element can be implemented as a magnetic device such an inductor, a transformer, and a choke. Although described in the context of polymeric layers, it will be understood that one or more features of the present disclosure can also be implemented in other types of laminate layers.

FIG. 2 schematically shows that in some embodiments, a polymeric laminate layer based device 100 having one or more inductive elements 102 can also include one or more magnetic materials 104. Examples of such magnetic materials are described herein in greater detail.

FIG. 3 schematically shows that in some embodiments, the laminate device 100 of FIG. 1 and/or FIG. 2 can be implemented as a magnetic component 110. Such a magnetic component can include an inductor, a transformer, and/or a choke. Although described in such example components, it will be understood that one or more features of the present disclosure can also be implemented in other types of devices.

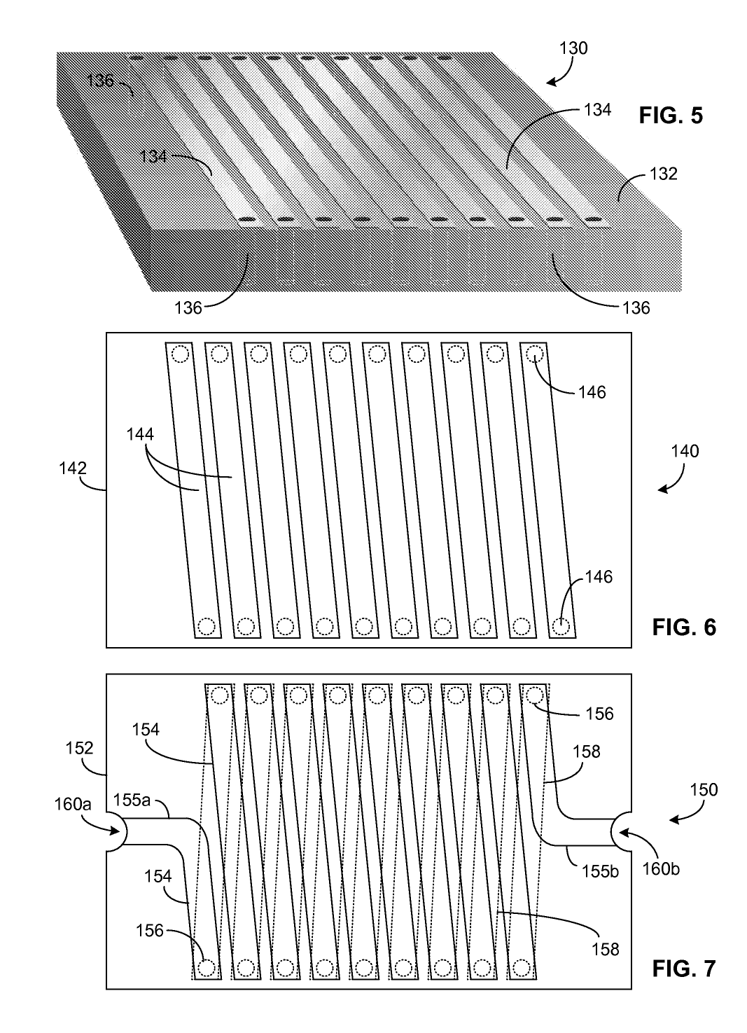

Devices having one or more features as described herein can be utilized generally without packaging, or as shown in FIG. 4, be implemented in a packaged device 120. Such a packaged device can include one or more magnetic components 110 of FIG. 3.

FIG. 5 shows an example of a laminate device 130 having a plurality of conductor features that can be configured to yield an inductive element. The conductor features can include a plurality of conductive ribbons 134 formed on or near a surface of a polymeric laminate layer 132. The ends of the conductive ribbons 134 are shown to be electrically connected to through-layer conductive vias 136.

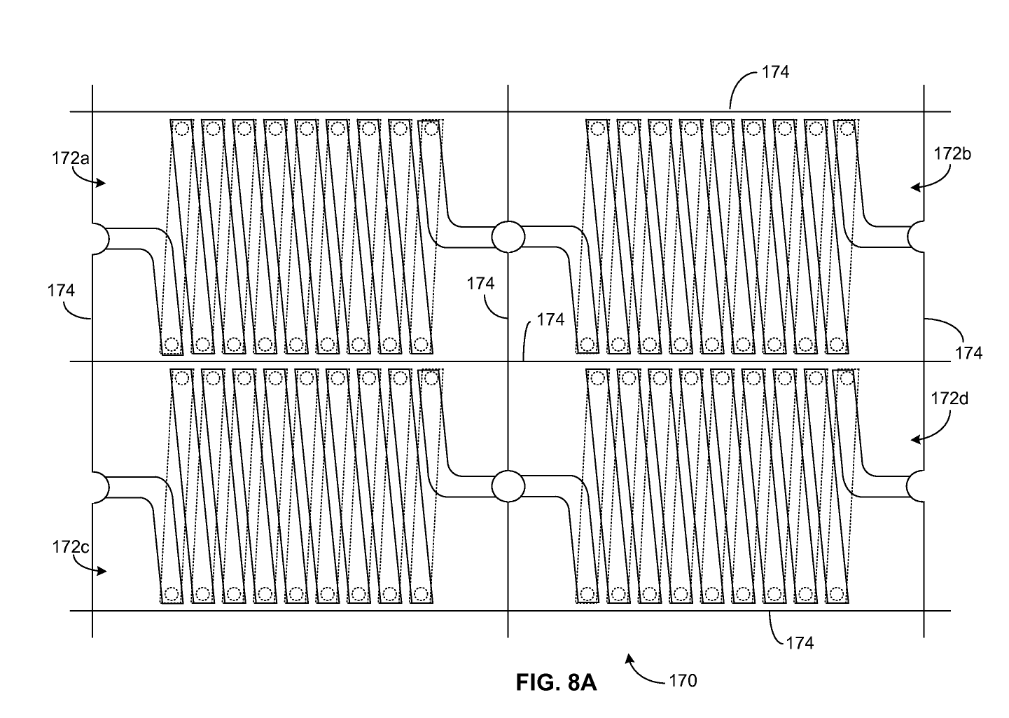

In some embodiments, the conductive ribbons can be formed on one side of the polymeric laminate layer (e.g., FIG. 6). By way of an example, such a configuration can be combined with another polymeric laminate layer to form a plurality of conductive windings that provide an electrical path through the conductive ribbons and the vias.

In some embodiments, the conductive ribbons can be formed on both sides of the polymeric laminate layer (e.g., FIG. 7). By way of an example, such a configuration can yield a self-contained layer having a plurality of conductive windings that provide an electrical path through the conductive ribbons and the vias.

For the purpose of description herein, a polymeric laminate layer can be a layer formed from any material utilized for printed circuit boards (PCBs), including by way of examples, copper foil, FR4 and prepreg. It will also be understood that a given polymeric laminate layer can be a single layer or a composite of two or more sub-layers. As described herein, a polymeric laminate layer can have one or more conductive features including straight and/or curved ribbons forming windings and/or conductive traces, on one or both exterior surfaces. As described herein, a polymeric laminate layer may or may not include polymeric magnetic materials that can provide magnetic cores for the inductive elements. Polymeric magnetic materials, by way of example, may be comprised of iron powders, ferrite powders, compounds/mixtures of these and/or other metals, polymer resins, inert fillers and lubricants. In some embodiments, a conductive layer such as a conductive polymeric film or a metal foil, including copper foil or nickel plated copper foil, can be laminated to one or both surfaces of a polymeric laminate layer which can optionally be comprised in total or in part of a polymeric magnetic material. In other embodiments, metal can be deposited on one or both surfaces of the polymeric laminate layer by, for example, plating, evaporation, sputtering, CVD deposition and other methods known in the industry. Conductive features can be formed from the conductive layer or layers by, for example, masking selected area and removing other selected areas to create conductive ribbons, conductive traces, contact pads or terminals. Optionally, these conductive features may be connected to through-layer vias formed by, for example, laser or mechanical drilling. These vias may optionally be plated, along with other areas of the laminate, to form conductors through one or more layers. Alternatively, these vias may be filled with polymeric insulator materials (non-electrically conductive materials) and a smaller diameter via drilled concentrically inside the insulator filled via followed by a plating operation. This could form a conductor which would penetrate through conductive layers in which the conductor would be electrically insulated from those conductive layers, but which could be connected to other conductive layers such as layers forming terminals on the exterior surfaces of the device. Using these example techniques, complex structures may be formed which can connect the exterior terminals to one or more conductive layers within the laminate structure, but which are electrically insulated from other conductive layers within the structure.

FIG. 6 shows that in some embodiments, one side of a polymeric laminate layer can be provided with one or more conductive features such as conductive ribbons. An example configuration 140 shows a plan view of a plurality of conductive ribbons 144 formed on a surface of a polymeric laminate layer 142. Such conductive ribbons are shown to be electrically connected to their respective conductive vias 146 that extend through the polymeric laminate layer 142 from the surface where the conductive ribbons are located. As described herein, an assembly of conductive windings can be formed by combining two appropriately configured devices 140 so that their vias connect electrically and the conductive ribbons are at the two outer surfaces. Also as described herein, one or more layers that yield one or more windings can be interposed between two such devices 140.

FIG. 7 shows that in some embodiments, both sides of a polymeric laminate layer can be provided with conductive features such as conductive ribbons. An example configuration 150 shows a plan view of a plurality of conductive ribbons 154 formed on a first surface (e.g., upper surface) of a polymeric laminate layer 152. Similarly, a plurality of conductive ribbons 158 are shown to be formed on a second surface (e.g., lower surface) of the polymeric laminate layer 152. Such conductive ribbons are shown to be electrically connected to their respective conductive vias 156 that extend through the polymeric laminate layer 152 between the two surfaces where the conductive ribbons 154, 158 are located.

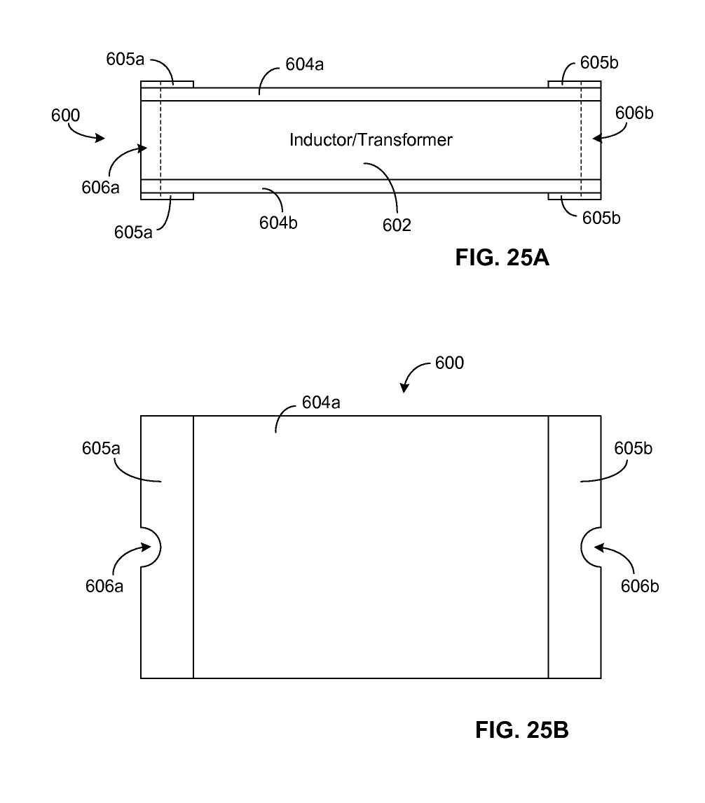

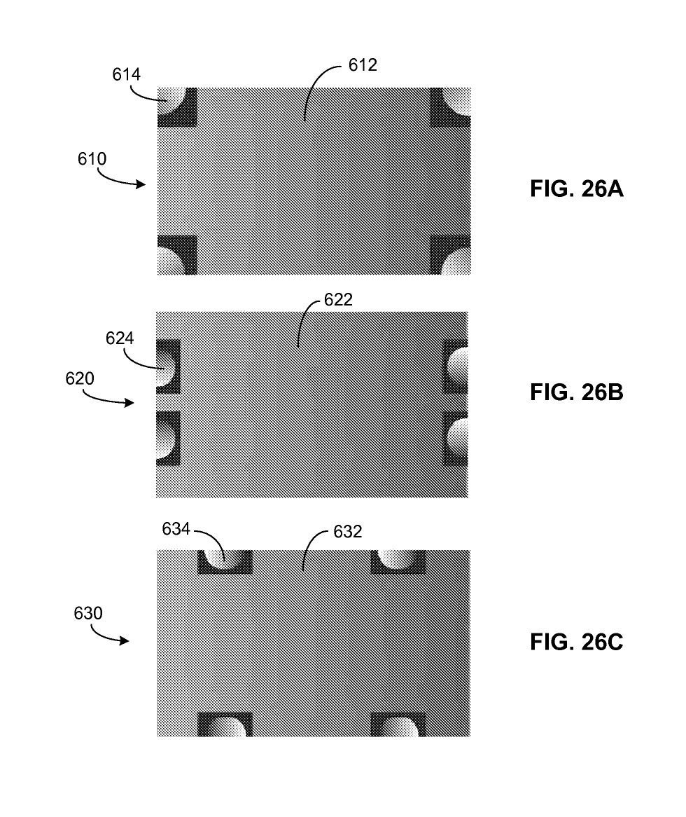

In the example shown, the conductive ribbons 154, 158 formed on the first and second surfaces and connected through the vias 156 form a winding between conductive traces 155a, 155b and their respective plated through-layer vias 160a and 160b, which in subsequent manufacturing steps can be electrically connected to terminals on the exterior of the completed package. Examples of such external terminals are described herein in greater detail in reference to FIGS. 25A-25B, 26A-26C and 32-35. Although the example terminals in FIG. 25B and FIGS. 26A-26C are shown to be on the second surface, they can also be on the first surface, or in some combination thereof. Although the example of FIG. 7 is described in the context of conductive traces interconnecting the ends of a winding with plated through-layer vias, it will be understood that other types of connection configurations can be implemented.

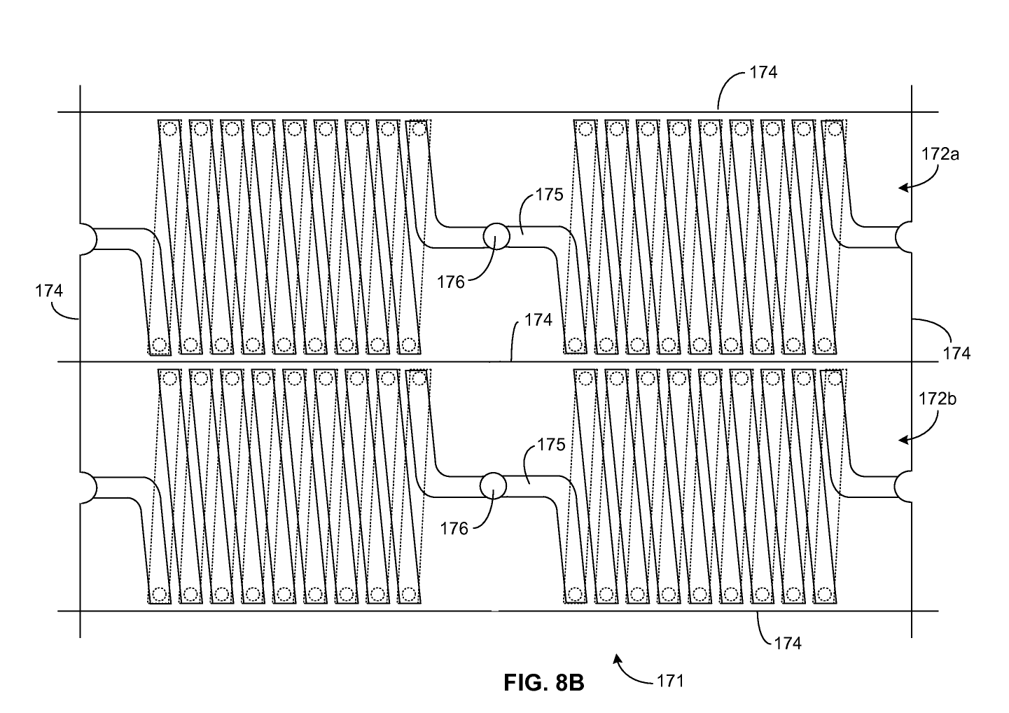

FIGS. 8A and 8B show that in some implementations, devices such as some or all of the examples described herein can be fabricated as an array. In an example configuration 170 of FIG. 8A, polymeric laminate layers 172a-172d and their respective conductive features are shown to be formed on a common sheet. Each winding is shown to include conductive traces interconnecting the ends of the winding to their respective plated through-layer vias, similar to those described in reference to FIG. 7. Upon partial or total completion, such devices can be singulated into, for example, individual devices. In some embodiments, such singulation can be facilitated by score lines 174 or other features that are configured to facilitate the separation of the devices. After singulation, the plated through-layer vias (e.g., located on the score lines) can become the castellations connecting each of the pairs of upper and lower terminals on each end as shown in FIGS. 25A and 25B.

FIG. 8B shows an example configuration 171 where two example polymeric laminate layers 172a, 172b and their respective conductive features. Each polymeric laminate layer is shown to include two windings joined by a conductive trace 175 and a plated through-layer via 176. The two ends of each assembly of such two windings can include conductive traces and their respective plated through-layer vias similar to those described in reference to FIG. 7. The plated through-layer vias 176 could provide an electrical connection to a point between the two windings.

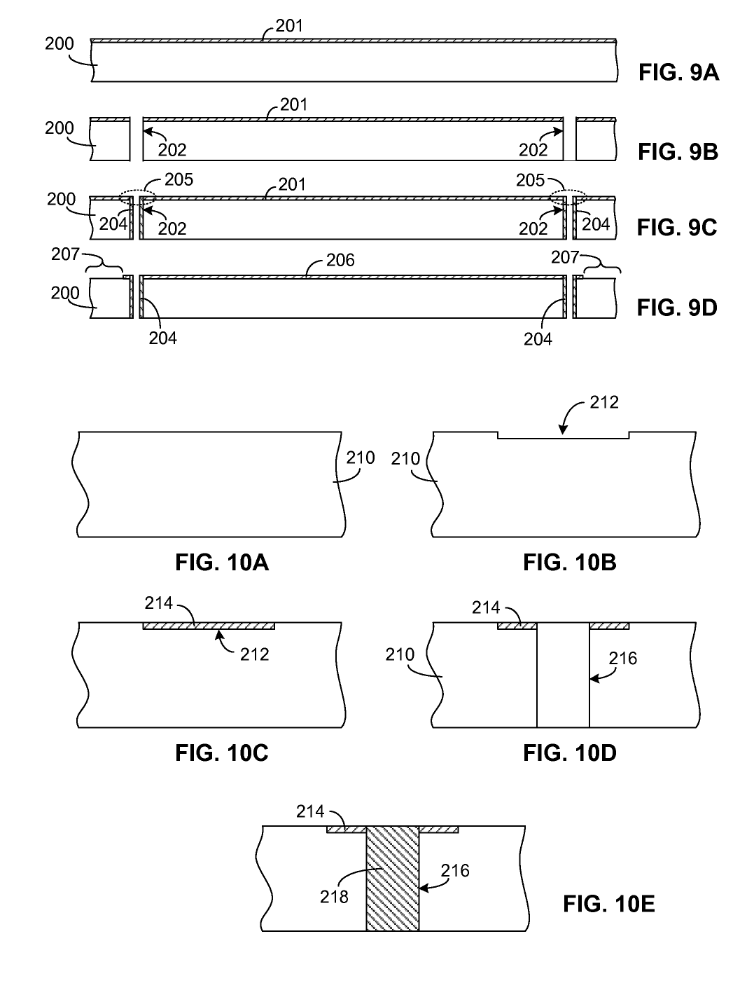

FIGS. 9A-9D and 10A-10E show examples of how conductive features such as conductive ribbons and vias can be formed on and through polymeric laminate layers. FIG. 9A shows a side sectional view of a polymeric laminate layer 200 upon which a conductive layer 201 is implemented (e.g., laminated to the upper surface of the polymeric laminate layer 200). In FIG. 9B, a plurality of through-layer vias 202 can be formed through the conductive layer 201 and the polymeric laminate layer 200. In some implementations, such vias can be formed by, for example, mechanical or laser drilling. FIG. 9C shows that, upon formation, the vias 202 can be plated with conductive material to form a conductive via 204 between the two sides of the polymeric laminate layer 200. Such plating can adhere to the inside of the vias 202 and also to the outer surface of the conductive layer 201 on the upper surface of the polymeric laminate layer 200. Such coverage of the plating on the outer surface of the conductive layer 201, to thereby provide electrical connections between the conductive vias 204 and the conductive layer 201 is depicted by dotted regions 205. The plating can also reduce electrical resistance and/or thermal resistance of the conductive layer 201.

In some embodiments, a conductive layer similar to the upper conductive layer 201, as well as similar plating coverage, can be implemented on the lower surface of the polymeric laminate layer 200. In such a configuration, the upper conductive layer 201 and the lower conductive layer (not shown) can be electrically connected through some or all of the foregoing conductive vias 204. In FIG. 9D, a conductive ribbon 206 is shown to be formed on an upper surface of the polymeric laminate layer 200 from the conductive layer 201 so as to electrically connect the two conductive vias 204. Such a conductive ribbon can be formed by, for example, the foregoing lamination of conductive layer(s) onto the polymeric laminate layer 200 followed by masked deposition, masked etching, laser patterning and plating, or some combination thereof, utilizing known techniques associated with masking, metal deposition including plating, and metal etching processes. In FIG. 9D, regions indicated as 207 are examples where selected regions of the conductive layer 201 have been removed (e.g., by etching) to yield a conductive feature (e.g., a conductive ribbon) as described herein. In some implementations, similar conductive ribbons can be formed on the lower surface of the polymeric laminate layer 200.

In some embodiments, the foregoing plating (e.g., configured to reduce the electrical resistance and/or thermal resistance of the conductive layer 201) can be obtained by a selective plating up process. In such a selective plating up, one or more additional plating cycles can be performed to build up the thickness of the plating to a desired configuration. For example, such an additional plating cycle can include a photolithography step associated with masking followed by plating and selective etching or photo mask removal operation.

In the example of FIG. 9D, the conductive ribbon 206 is depicted as protruding above the upper surface. Further, the conductive vias 204 are depicted as having a conductive wall. FIG. 10 shows that other configurations are also possible. For example, a recessed street can be formed for receiving a conductive ribbon, so that the conductive ribbon is at least partially positioned within the recessed street. In another example, a through-layer via can be formed after the formation of a conductive ribbon. In yet another example, a through-layer via can be substantially filled with conductive material. Other variations can also be implemented.

As shown in FIG. 10A, a polymeric laminate layer 210 can be provided. FIG. 10B shows that a recessed street 212 can be formed on one or both sides of the polymeric laminate layer 210. FIG. 10C shows an end sectional view of a conductive ribbon 214 formed within the recessed street 212. FIG. 10D shows a via 216 formed through the conductive ribbon 214 and the polymeric laminate layer 210. FIG. 10E shows that in some embodiments, such a via can be filled with conductive material 218 such as metal so as to electrically connect the conductive ribbon 214 on the upper surface with another conductive feature (not shown) on the lower surface.

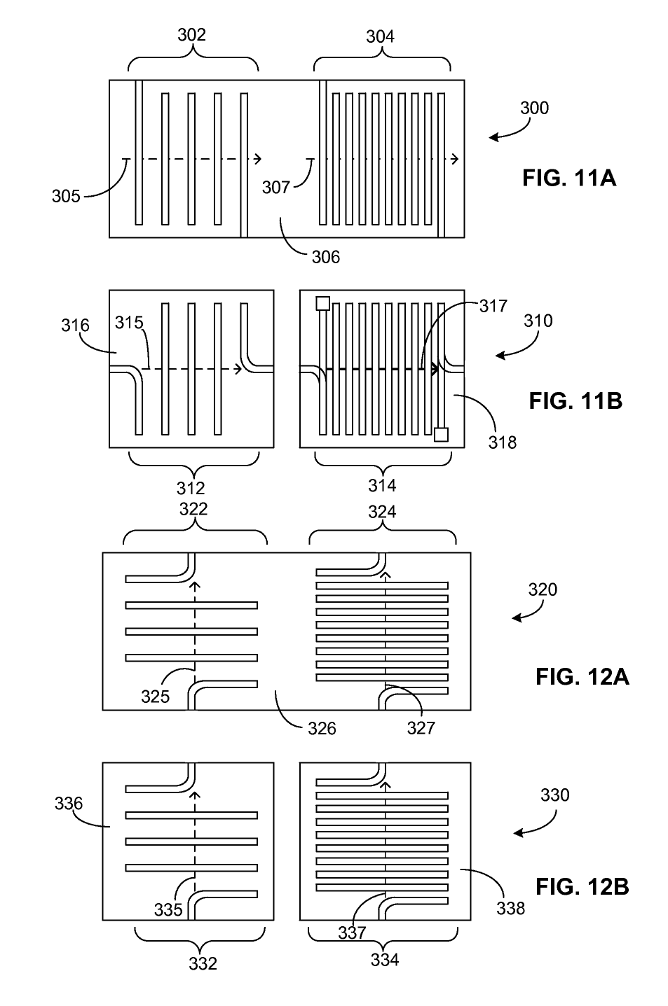

In some implementations, two or more windings such as the examples of FIGS. 5-10 can be positioned relative to each other to yield magnetic devices such as transformers. FIGS. 11A and 11B show example configurations where first and second windings can be arranged so that their respective axes of magnetic fluxes are generally co-axial but offset longitudinally. In an example configuration 300 of FIG. 11A, first and second windings 302, 304 are shown to be disposed on a common substrate layer 306. Such windings can be positioned relative to each other on the common substrate layer to obtain a desired magnetic coupling between the first and second windings 302, 304. A magnetic flux axis 305 is depicted for the first winding 302, and a magnetic flux axis 307 is depicted for the second winding 304. In the example shown, the first and second magnetic axes 305, 307 can be generally co-axial and offset longitudinally.

In an example configuration 310 of FIG. 11B, first and second windings 312, 314 are shown to be disposed on separate substrate layers 316, 318. Such separate substrate layers can be dimensioned and/or positioned relative to each other to obtain a desired magnetic coupling between the first and second windings 312, 314. A magnetic flux axis 315 is depicted for the first winding 312, and a magnetic flux axis 317 is depicted for the second winding 314. In the example shown, the first and second magnetic axes 315, 317 can be generally co-axial and offset longitudinally.

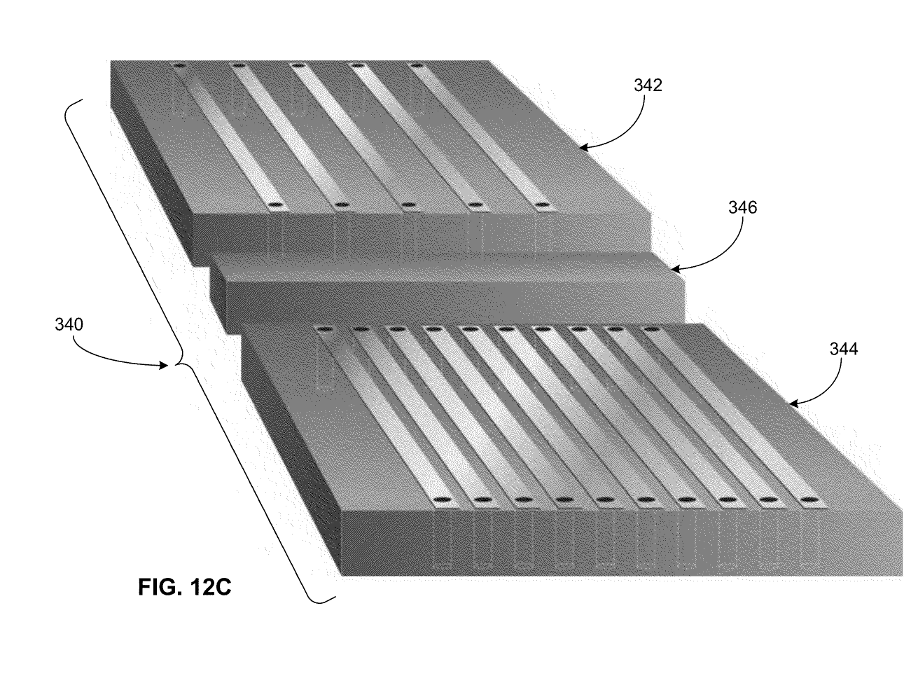

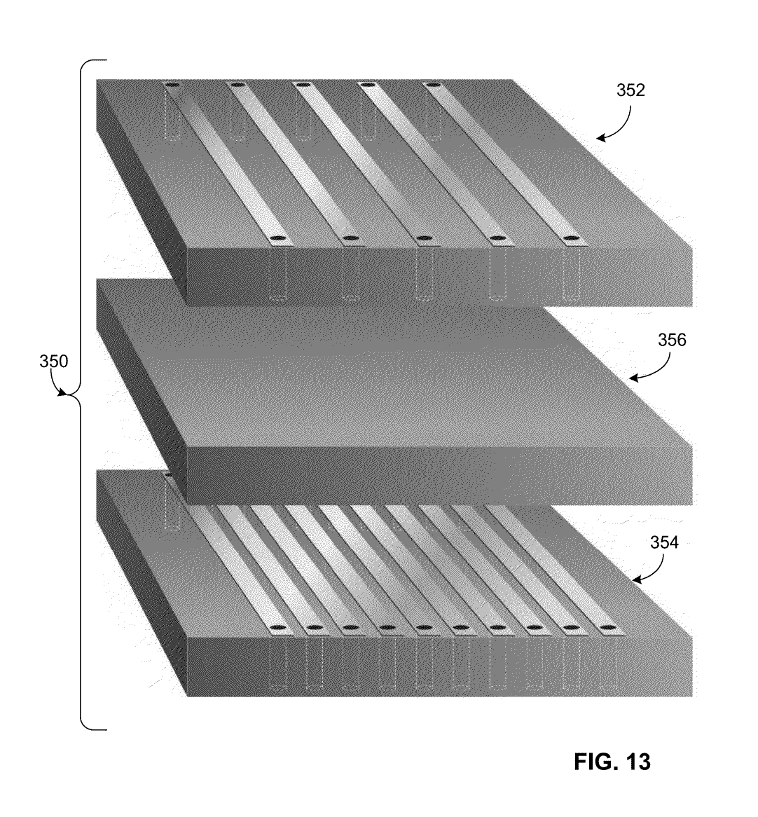

FIGS. 12A and 12B show example configurations where first and second windings can be arranged so that their respective axes of magnetic fluxes are generally parallel but offset laterally. In an example configuration 320 of FIG. 12A, first and second windings 322, 324 are shown to be disposed on a common substrate layer 326. Such windings can be positioned relative to each other on the common substrate layer to obtain a desired magnetic coupling between the first and second windings 322, 324. A magnetic flux axis 325 is depicted for the first winding 322, and a magnetic flux axis 327 is depicted for the second winding 324. In the example shown, the first and second magnetic axes 325, 327 can be generally parallel and offset laterally. The first and second magnetic axes 325, 327 can also be opposed to each other to achieve other desired magnetic properties. An example of this could be to create a circular magnetic field within the common substrate layer 326. This structure could include an opening in the center of the circular magnetic field to help direct the field to achieve the desired magnetic properties. In another embodiment, one or more openings in common substrate layer 326 could be formed by, for example, punching, laser or mechanical drilling which could be filled with a gas or a non-magnetic material creating the gaps which are often utilized in the construction of magnetic devices, particularly transformers, which can change the properties of the magnetic field to achieve the desired magnetic properties.

In an example configuration 330 of FIG. 12B, first and second windings 332, 334 are shown to be disposed on separate substrate layers 336, 338. Such separate substrate layers can be dimensioned and/or positioned relative to each other to obtain a desired magnetic coupling between the first and second windings 332, 334. A magnetic flux axis 335 is depicted for the first winding 332, and a magnetic flux axis 337 is depicted for the second winding 334. In the example shown, the first and second magnetic axes 335, 337 can be generally parallel and offset laterally. The first and second magnetic axes 335, 337 can also be opposed to each other as necessary or desired to achieve the example desired inductive properties as described in reference to FIG. 12A.

FIG. 12C shows a perspective view of an example configuration of an assembly 340 that is similar to the example of FIG. 12B. In this example, a spacer 346 is shown to be disposed between substrate layers associated with first and second windings 342, 344. The spacer 346 can be dimensioned to provide a desired separation and/or alignment between the two substrate layers. In some embodiments, the spacer 346 can be formed from an electrically insulating material. In some embodiments, the spacer 346 can be formed from non-magnetic material, magnetic material, or some combination thereof.

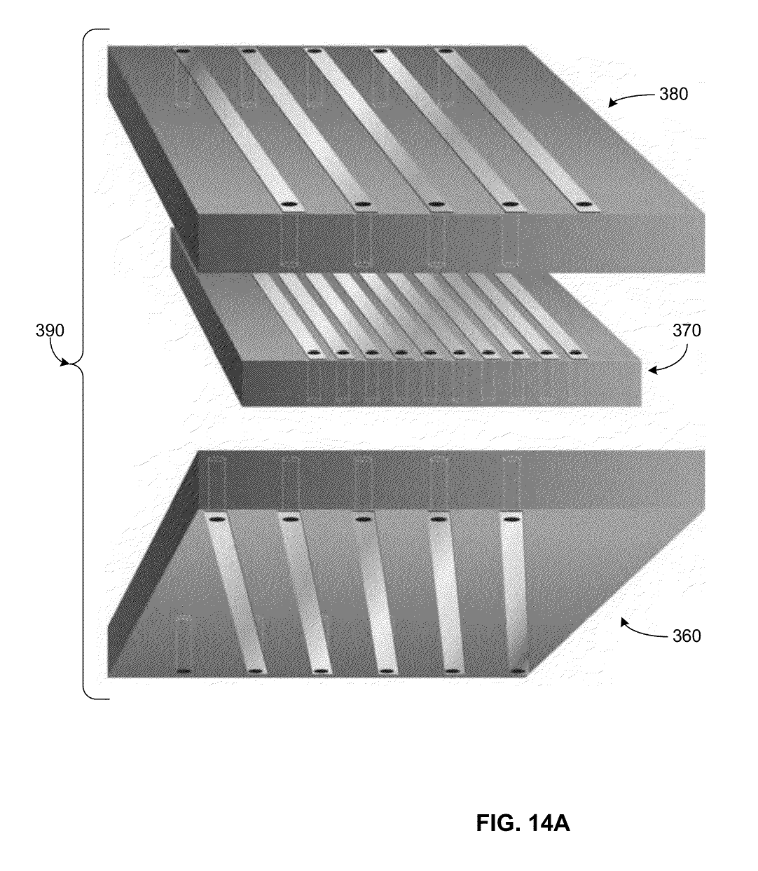

In the examples described in reference to FIGS. 11 and 12, the first and second windings are generally positioned in a common plane. FIG. 13 shows an exploded view of an example assembly where first and second windings can be positioned in different planes. In an example configuration 350, a first substrate layer with a corresponding first winding 352 is shown to be positioned above a second substrate layer with a corresponding second winding 354. In some embodiments, a spacer layer 356 can be disposed between the first and second substrate layers. The spacer layer 356 can be dimensioned to provide a desired separation and/or electrical isolation between the two windings 352, 354.

In the example shown, the first and second substrate layers and the spacer layer 356 can be stacked together so as to form a stack configuration. In some embodiments, the spacer layer 356 can be formed from an electrically insulating material. In some embodiments, the spacer layer 356 can be formed from non-magnetic material, magnetic material, or some combination thereof.

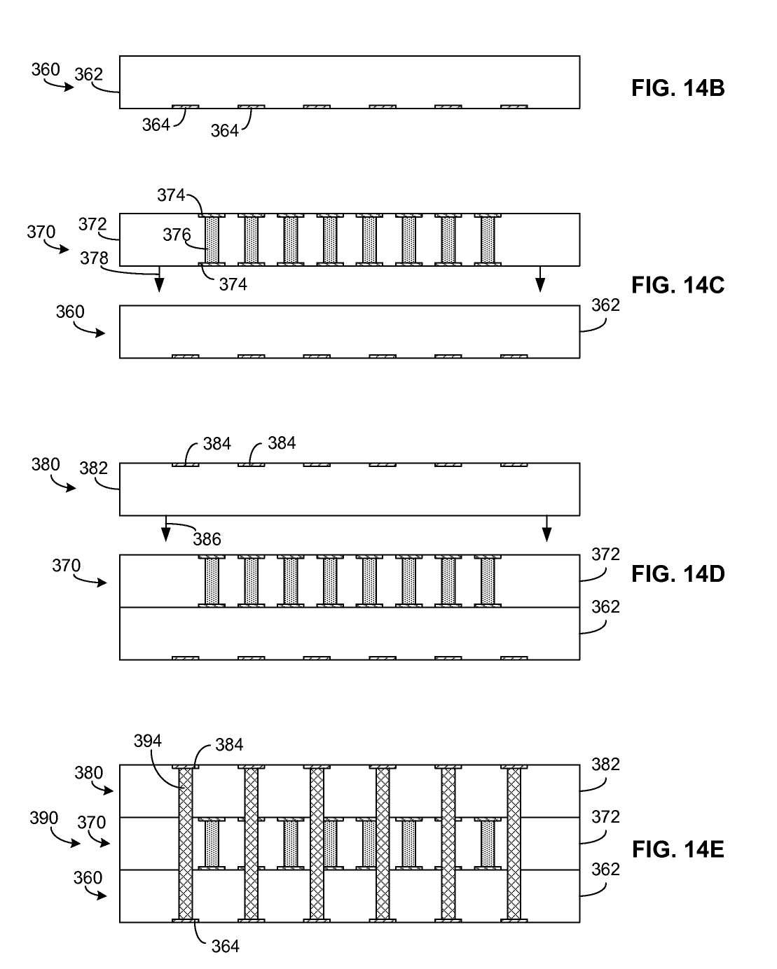

In some embodiments, one winding can be nested within another winding. FIGS. 14A-14E show an example of such a configuration. FIG. 14A depicts a perspective unassembled view of a stack assembly having subassemblies 360, 370, 380, and FIGS. 14B-14E show various stages of an example fabrication process that can be implemented to obtain such a nested configuration.

In FIG. 14B, an assembly 360 having a plurality of conductive ribbons 364 on one side of a substrate layer 362 can be formed or provided. For the purpose of description of FIGS. 14A-14E, through-layer vias have not been formed at this stage. However, it will be understood that the assembly 360 can have vias formed at this stage.

In FIG. 14C, an assembly 370 having a plurality of conductive ribbons 374 on each of the two sides of a substrate layer 372 can be formed or provided. In some embodiments, the assembly 370 can further include vias 376 that connect their respective conductive ribbons 374. In some implementations, such an assembly (370) can be positioned (arrows 378) over the side of the assembly 360 without the conductive ribbons. In some embodiments, the assembly 370 can be positioned directly on the assembly 360.

In FIG. 14D, an assembly 380 having a plurality of conductive ribbons 384 on one side of a substrate layer 382 can be formed or provided. For the purpose of description of FIGS. 14A-14E, through-layer vias have not been formed at this stage. However, it will be understood that the assembly 380 can have vias formed at this stage. In some embodiments, the assembly 380 can be configured to complement the assembly 360 when oriented so that their sides without the conductive ribbons are facing each other. In some implementations, such an assembly (380) can be positioned (arrows 386) over the assembly 370 that had previously been positioned over the assembly 360. In some embodiments, the assembly 380 can be positioned directly on the assembly 370.

FIG. 14E shows the assemblies 360, 370, 380 stacked together to yield a stack assembly 390. A plurality of conductive vias 394 are shown to be formed so as to connect their respective conductive ribbons 364 (of the assembly 360) and 384 (of the assembly 380). In some embodiments, the conductive vias 394 can be formed by mechanical or laser drilling through the substrate layers 382, 372, 362 and the conductive ribbons 384, 364.

In some embodiments, lateral dimensions of the winding associated with the middle layer 370 can be selected to be smaller than lateral dimensions of the winding associated with the upper and lower layers 380, 360. Such a configuration can allow the winding of the middle layer 370 to be nested within the winding associated with the upper and lower layers 380, 360. Such a configuration can also allow the formation of the vias 394 to be implemented without impacting the nested winding of the middle layer 370.

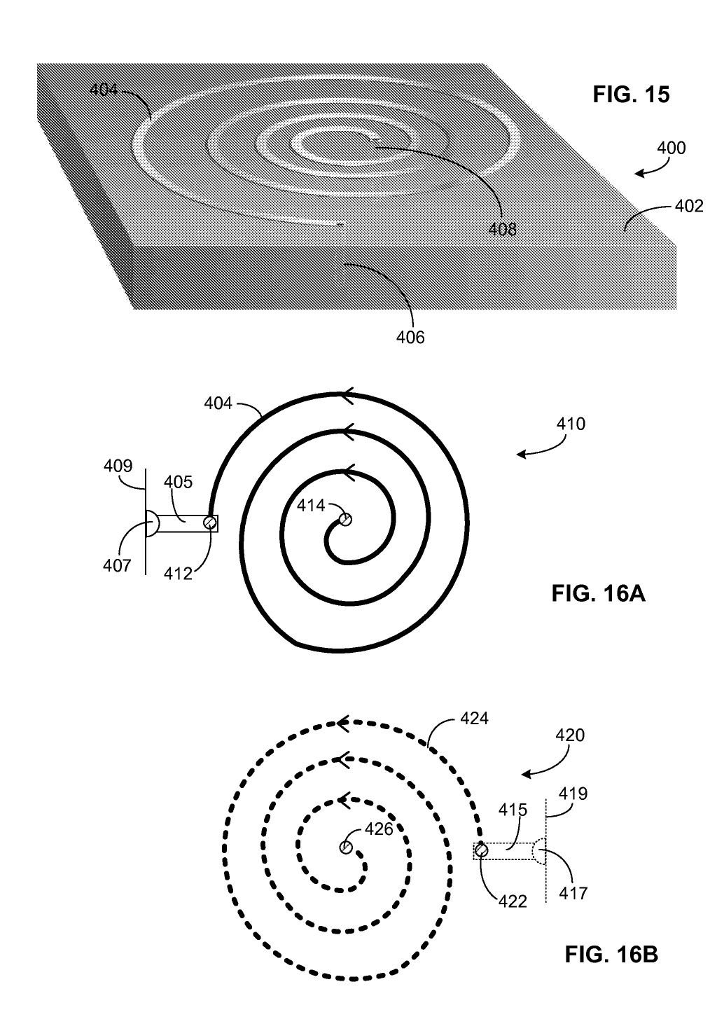

In the various examples described herein in reference to FIGS. 5-14, the conductive ribbons are depicted as being generally straight strips. It will be understood that such conductive ribbons can also have other shape, including curves and bends to accommodate different winding configurations. FIG. 15 shows an example configuration 400 where a conductive ribbon 404 formed on a laminate substrate 402 has a spiral shape.

A first end (e.g., an outer end) and a second end (e.g., an inner end) of the spiral ribbon 404 can be connected to their respective conductive vias 406, 408 that extend through the laminate substrate 402. In a configuration where another spiral ribbon is provided on the other side (not shown in FIG. 15), one or both of the conductive vias 406, 408 can facilitate the connections of the upper spiral ribbon 404 with the lower spiral ribbon. In a configuration where the laminate substrate 402 is to be utilized with another polymeric laminate layer, the conductive vias 406, 408 can facilitate the connections of the spiral ribbon with a conductive ribbon (e.g., another spiral ribbon).

In some implementations, a plurality of spiral ribbons on two sides of a given laminate substrate, on separate laminate substrates, or some combination thereof can be connected such that magnetic fields generated by the spiral ribbons do not cancel each other to thereby yield a magnetic device with enhanced net magnetic field. For example, FIGS. 16A and 16B show how two windings 410, 420 can be connected (e.g., through a conductive via at inner ends 414, 426 of the windings 410, 420) so that currents flowing through them generate magnetic fields that enhance each other. Suppose that the winding 410 is on the upper surface of a laminate substrate (e.g., 402 in FIG. 15), and the winding 420 is on the lower surface of the same laminate substrate. As shown in FIG. 16A, a current flowing from the inner end 414 to the outer end 412 of the spiral ribbon 404 results in a magnetic field axis generally pointing out of the depicted plane. As shown in FIG. 16B (viewed from the top, similar to FIG. 16A), a current flowing from the outer end 422 to the inner end 426 of the spiral ribbon 424 results in a magnetic field axis generally pointing out of the depicted plane. Since the winding 420 is on the lower side of the example laminate substrate, the axes of the magnetic fields generated in the foregoing manner generally align and enhance each other (e.g., upward).

In the example of FIGS. 16A and 16B, the outer end 412 of the upper spiral ribbon 404 can be connected to a plated through-layer via 407 (e.g., positioned along a line 409 that will become an edge when singulated) through a conductive trace 405. Similarly, the outer end 422 of the lower spiral ribbon 424 can be connected to a plated through-layer via 417 (e.g., positioned along a line 419 that will become an edge when singulated) through a conductive trace 415.

To obtain the foregoing current flow directions, the two windings 410, 420 can be isolated from each other and be supplied from separate current sources. Alternatively, the two windings 410, 420 can be connected and supplied from a common current source. For example, if the outer end 422 of the lower winding 420 is connected to a current source, the inner end 426 of the lower winding 420 can be connected to the inner end 414 of the upper winding 410 (e.g., through a conductive via) to yield the foregoing example current flow. In another example, if the inner end 414 of the upper winding 410 is connected to a current source, the outer end 412 of the upper winding 410 can be connected to the outer end 422 of the lower winding 420 (e.g., through a conductive via) to yield the foregoing example current flow.

If the two windings in the examples of FIGS. 15 and 16 are electrically isolated from each other, the assembly of the two windings can function as a transformer. In such a configuration, the winding densities of the two windings can be different to provide a desired step-up or step-down functionality.

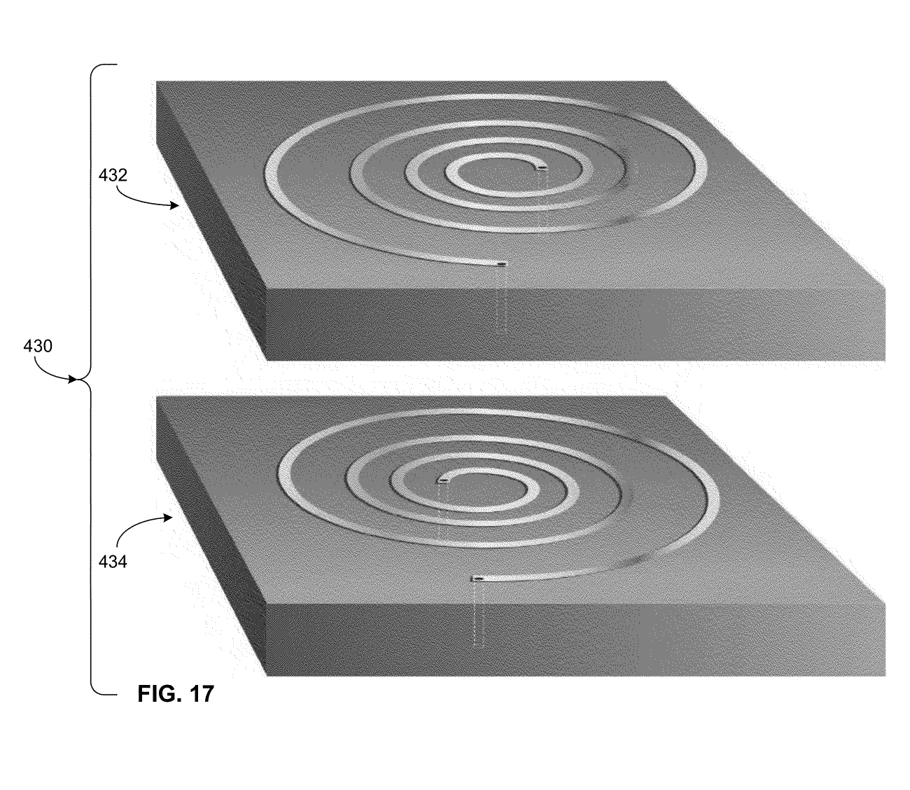

As described herein, two or more spiral ribbons can be implemented on separate polymeric laminate layers. FIG. 17 shows an exploded view of an example assembly 430 having two separate polymeric laminate layers 432, 434 each having one or more spiral ribbons. As described herein, such spiral ribbons can be configured and connected so as to function as an inductor, or as a transformer.

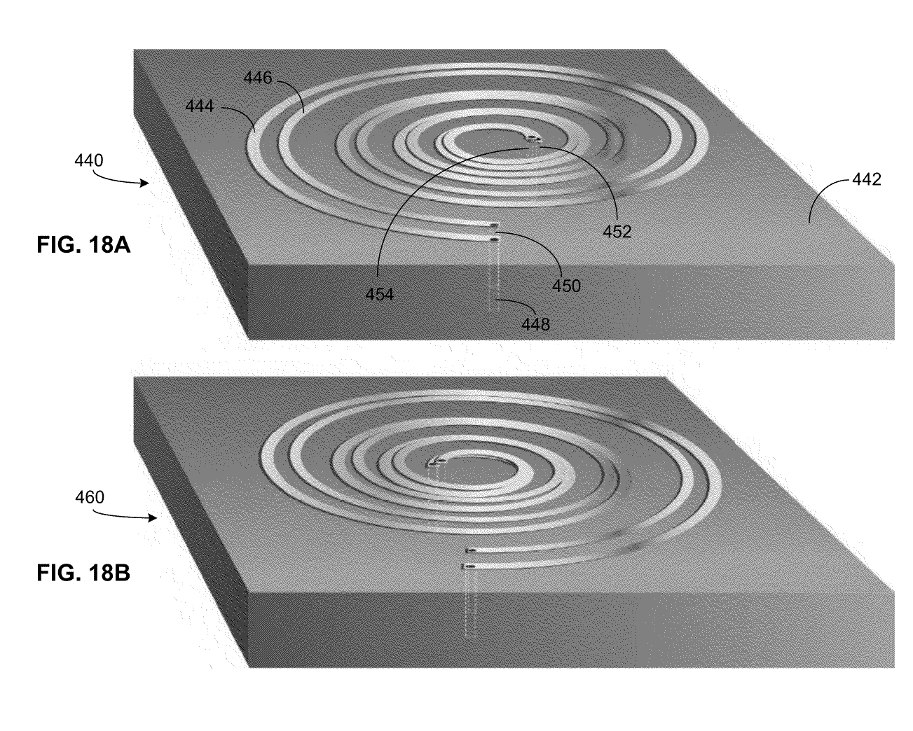

FIG. 18A shows that in some implementations, a given surface of a laminate substrate can be provided with more than one spiral ribbon. For example, a configuration 440 is shown to include first and second spiral ribbons 444, 446 formed on one side of a laminate substrate 442. Such spiral ribbons can be electrically isolated, and some or all of their ends can be electrically connected to their respective conductive vias (e.g., 448 and 452 for the spiral ribbon 444, and 450 and 454 for the spiral ribbon 446).

If utilized as an inductor the two spiral ribbons can be connected so as to yield an increase (e.g., approximately double by the two spirals being generally parallel) the effective winding on the same surface of the laminate substrate. If utilized as a transformer, the two spiral ribbons can be configured (e.g., different winding density) and connected (e.g., each spiral having separate input and output) to yield a desired step-up or step-down functionality.

In some implementations, the foregoing example of two or more spiral ribbons being formed on one side of a give polymeric laminate layer can be extended to the other side of the same polymeric laminate layer. Such multiple spirals on the two sides of the polymeric laminate layer can be configured and interconnected appropriately to yield various devices such as an inductor, a choke, or a transformer.

As shown in FIGS. 18A and 18B, the foregoing example of two or more spiral ribbons being formed on one side of a give polymeric laminate layer can be extended to another polymeric laminate layer 460. Such multiple spirals on the different polymeric laminate layer can be configured and interconnected appropriately to yield various devices such as an inductor, a choke, or a transformer.

In some implementations, the various examples of spiral ribbons and their corresponding conductive vias can be formed on laminate substrates in manners similar to those described in reference to FIGS. 9 and 10. Further, in some implementations, an array of devices having such spiral ribbons can be fabricated together in a manner similar to that described in reference to FIG. 8.

As described herein, a polymeric laminate layer with conductive ribbon strips (e.g., FIGS. 5-8) yields a magnetic field axis that is generally parallel to the plane of the polymeric laminate layer. Also as described herein, a polymeric laminate layer with one or more conductive ribbon spirals (e.g., FIGS. 15-18) yields a magnetic field axis that is generally perpendicular to the plane of the polymeric laminate layer. When such a ribbon-strip device and such a ribbon-spiral device are positioned close to each other (e.g., in a stack), the two magnetic fields can be generally perpendicular to each other. In such a configuration, the operations of the two devices may not interfere significantly with each other. Accordingly, two such devices can be combined to provide generally separate functionalities with little or no interference, and in a compact form.

FIG. 19 shows an exploded view of an example assembly 470 where one or more devices having ribbon strips (472) can be stacked together with one or more ribbon spirals (474, 476). In such a configuration, the ribbon-strip device 472 has a magnetic field that is directed along the plane of its laminate substrate, and the ribbon-spiral devices 474, 476 have magnetic fields that are directed along a direction perpendicular to the magnetic field of the ribbon-strip device 472. As described above, such perpendicular magnetic fields can allow the foregoing devices to be stacked together with little or no interference among each other.

In the various examples of polymeric laminate layers described herein, material within a volume within and/or next to conductive feature(s) may or may not provide magnetic core functionality. For non-magnetic core configurations, non-magnetic materials associated with, for example, PCB technologies can be utilized.

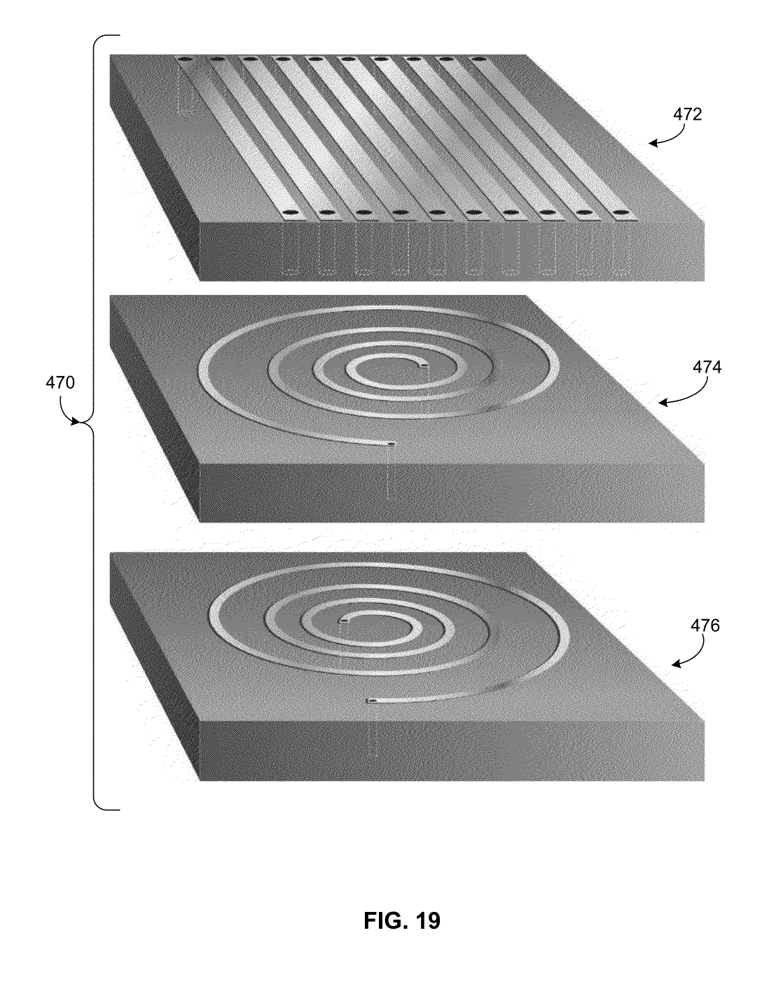

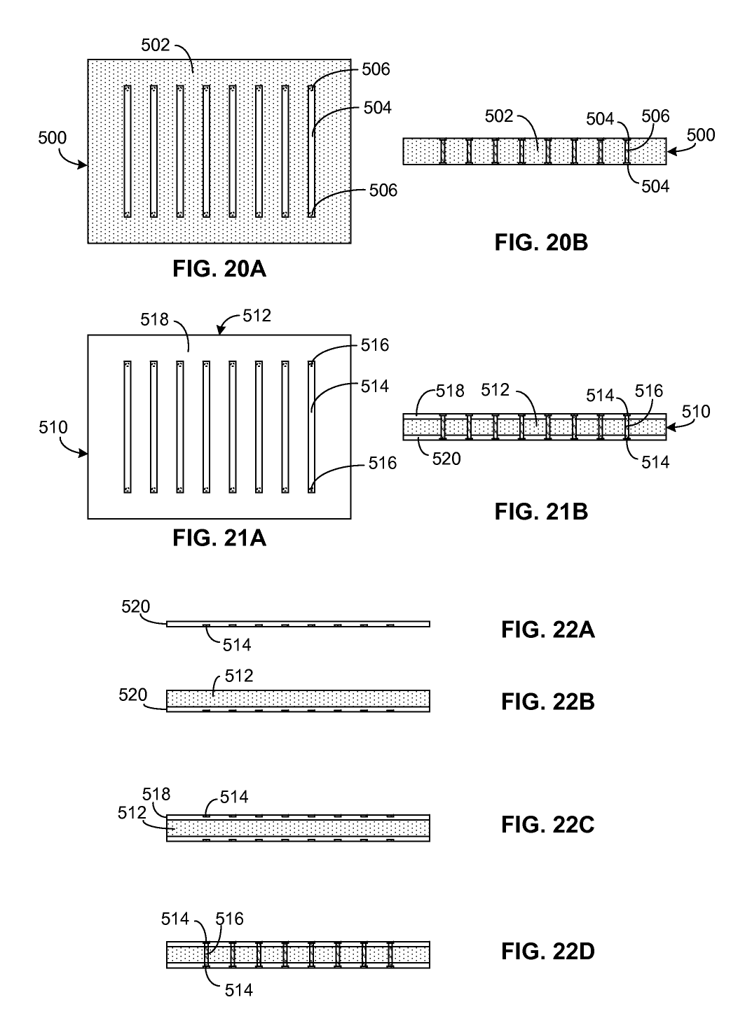

As is generally known, a magnetic core of a magnetic device can increase the magnetic field flux density thereby increasing the related parameters such as inductance. For magnetic core configurations, a magnetic core can be implemented in a number of ways. For example, FIGS. 20A and 20B show a configuration 500 where a polymeric laminate layer 502 is formed from a magnetic material. Preferably, such a magnetic material is non-conductive such that the conductive features are not shorted. Non-conductive polymeric magnetic materials, by way of example, can include non-conductive polymeric materials which surround iron powders, ferrite powders, compounds/mixtures of these and/or other metals when blended together with, for example, polymer resins, inert fillers and lubricants to achieve the desired magnetic and non-conductive properties.

In the example configuration 500 of FIGS. 20A and 20B, a plurality of ribbon strips 504 and their corresponding vias 506 are shown to form a winding on the magnetic layer 502. It will be understood that other types of ribbon configurations (e.g., ribbon spirals) can also be implemented on such a magnetic layer 502.

FIGS. 21A and 21B show another example configuration 510 where magnetic material 512 partially occupies the overall laminate device. In the side sectional view of FIG. 21B, the example laminate device is shown to include the magnetic-material layer 512 sandwiched between two non-magnetic layers 518, 520. Ribbon strips 514 are shown to be formed on the outer surfaces of the non-magnetic layers 518, 520, and conductive vias 516 are shown to interconnect their respective ribbon strips 514. It will be understood that other types of ribbon configurations (e.g., ribbon spirals) can also be implemented on such a laminate device.

FIGS. 22A-22D show an example of how the laminate device of FIGS. 21A and 21B can be fabricated. In FIG. 22A, a first non-magnetic layer 520 can be provided. A plurality of ribbon strips 514 are shown to be already formed on one side of the first non-magnetic layer 520. Although described in such a context, it will be understood that such ribbon strips can also be formed after the various layers (e.g., 520, 512, 518) are assembled.

In FIG. 22B, a magnetic layer 512, which could be a polymeric magnetic layer, is shown to be mounted on the first non-magnetic layer 520. In FIG. 22C, a second non-magnetic layer 518 is shown to be mounted on the magnetic layer 512. A plurality of ribbon strips 514 are shown to be already formed on one side of the second non-magnetic layer 518. Although described in such a context, it will be understood that such ribbon strips can also be formed after the various layers (e.g., 520, 512, 518) are assembled. It will be understood that such ribbon strips can also be formed directly on one or both surfaces of the magnetic layer 512.

In FIG. 22D, the three example layers 520, 512, 518 are shown to be assembled. A plurality of conductive vias 516 can be formed so as to electrically connect their respective ribbon strips 514.

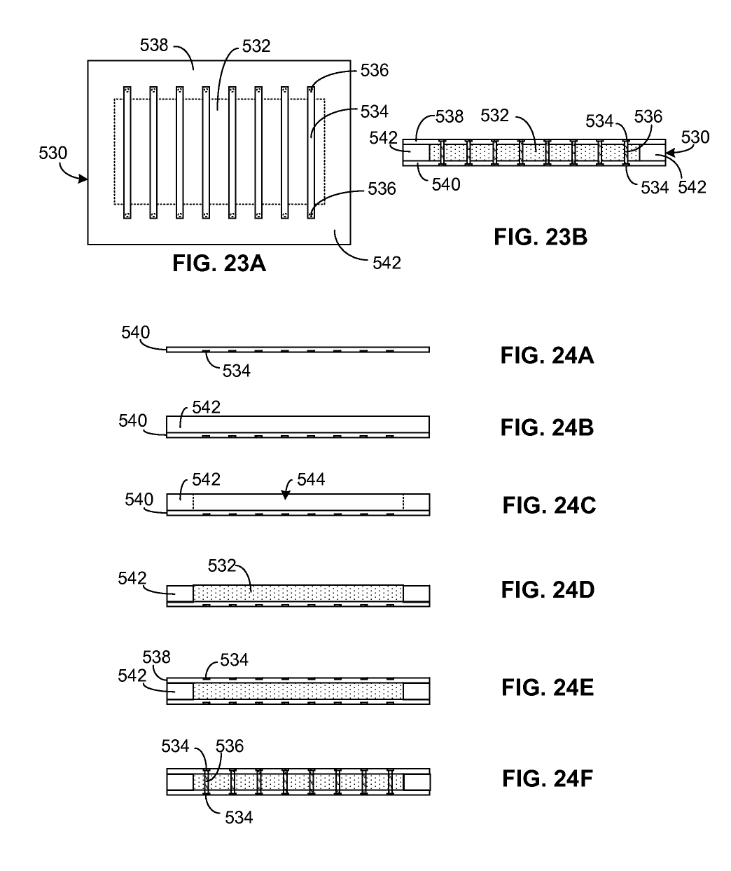

FIGS. 23A and 23B show an example of how the partial-magnetic region configuration of FIGS. 21 and 22 can be varied. Referring to the example configuration 530, suppose that it is desirable to limit a magnetic region 532 to a volume that is generally within a core volume defined by a winding. Such a winding is depicted as ribbon strips 534 interconnected by their respective vias 536. The magnetic region 532 is depicted as being sandwiched between first and second non-magnetic layers 540, 538, and being surrounded laterally by a border 542.

FIGS. 24A-24F show an example of how the laminate device of FIGS. 23A and 23B can be fabricated. In FIG. 24A, a first non-magnetic layer 540 can be provided. A plurality of ribbon strips 534 are shown to be already formed on one side of the first non-magnetic layer 540. Although described in such a context, it will be understood that such ribbon strips can also be formed after the various layers are assembled.

In FIG. 24B, a second non-magnetic layer 542 is shown to be mounted on the first non-magnetic layer 540. In FIG. 24C, a recess 544 can be formed on the second non-magnetic layer 542, such that the remaining portion of the layer 542 forms a border about the recess 544. In some implementations, such a border can be pre-fabricated and be mounted on the first non-magnetic layer 540.

In FIG. 24D, the recess 544 of FIG. 24C can be filled with magnetic material 532, which could be a polymeric magnetic material. By way of examples, such magnetic material can be deposited into the recess 544, or a pre-fabricated and dimensioned magnetic slab 532 can be inserted into the recess 544. It will be understood that ribbon strips can also be formed directly on one or both surfaces of the magnetic region 532.

In FIG. 24E, a third non-magnetic layer 538 can be mounted over the border 542 and the magnetic region 532. A plurality of ribbon strips 534 are shown to be already formed on one side of the third non-magnetic layer 538. Although described in such a context, it will be understood that such ribbon strips can also be formed after the various layers are assembled.

In FIG. 24F, the various parts 540, 542, 532, 538 are shown to be assembled. A plurality of conductive vias 536 can be formed so as to electrically connect their respective ribbon strips 534.

Based on the examples described in reference to FIGS. 20-24, it should be readily apparent that any number of other configurations are also possible to introduce a magnetic core to a winding as described herein.

A planar magnetic device having one or more features as described herein can have conductive ribbons disposed on one or more outward-facing sides. In some situations, such a bare device can be implemented directly in a circuit by providing appropriate electrical connections (e.g., contact pads) associated with the conductive ribbons together with appropriate electrical insulation from portions of the circuit.

In many situations, it may be desirable to package the planar magnetic device to provide various desirable features and functionalities. For example, a packaged device can provide protection and ease of handling. In another example, a packaged device can be configured to facilitate easier electrical connections with external parts.

FIG. 25A schematically depicts a packaged device 600 having a planar magnetic device 602 such as an inductor or a transformer. The planar magnetic device 602 can have one or more features as described herein. In some embodiments, the planar magnetic device 602 can be sandwiched between two packaging layers 604a, 604b. Such packaging layers can be configured in different manners to provide desired functionalities utilizing, for example, magnetic or non-magnetic materials.

For example, each of the two packaging layers 604a, 604b can be configured to provide shielding functionality for the planar magnetic device. In situations where the shielding is against static or slowly varying magnetic fields, the shielding layers can be formed from or be impregnated with, for example, high magnetic permeability metal alloys.

In some implementations, one or both of the packaging layers 604a, 604b can be configured to facilitate electrical connections between the planar magnetic device 602 and external contact pads or terminals. FIG. 25A depicts terminal pairs, 605a and 605b, located on packaging layers 604a, 604b at each end of the device. The plan view in FIG. 25B schematically depicts terminals at both ends of the packaging layer 604a. These terminals can be connected by conductive through-layer vias, which, after singulation, become semi-circular castellations, 606a and 606b, to their respective terminal on the packaging layer 604b, thus creating two terminal pairs, 605a, 605b, at the ends of the device. These terminal pairs can be electrically connected to selected conductive features within the laminated structure and electrically insulated from other features within the laminated structure. These terminal pairs can be utilized to make electrical and/or mechanical connection to a PCB and/or to another device, or a combination thereof. The terminal pairs can be configured to make the device generally symmetrical end to end or top to bottom to facilitate placement on the PCB. Optionally, the packaged device may have terminals on only one side, such as on packaging layer 604a.

FIGS. 26A-26C show examples of electrical contact features that can be implemented on a given packaging layer. In an example configuration 610 of FIG. 26A, electrical terminals 614 are shown to be formed at each of the four corners of one side of a packaging layer 612. In another example configuration 620 of FIG. 26B, two electrical terminals 624 are shown to be formed along each of the two shorter sides of a rectangular shaped packaging layer 622. In another example configuration 630 of FIG. 26C, two electrical terminals 634 are shown to be formed along each of the two longer sides of a rectangular shaped packaging layer 632. It will be understood that one or more features associated with such example electrical contact features on packaging layers can be implemented to provide packaging and electrical functionalities for some or all of the planar magnetic devices described herein.

It is readily apparent that a number of other connection terminal configurations can be implemented. In some embodiments, such terminals can be castellated to facilitate, for example, inspection of solder fillets on the terminations after the packaged device is soldered onto a circuit board. In some embodiments, such terminals can be electrically connected to the various connection points on the planar magnetic device by, for example, vias and/or conductive traces.

As described herein, an array of polymeric laminate based devices can be fabricated on a common layer. FIGS. 8A and 8B are examples where such individual devices are depicted as being formed on a common layer. As also described herein, a plurality of such individual devices can be stacked to yield desirable functionalities. FIGS. 13, 14A-14E and 17-19 are examples where two or more individual devices are depicted as being stacked. As described in reference to FIGS. 8A and 8B, fabrication of such stacked devices can also be achieved in a stack of arrays, followed by singulation into individual stacked devices.

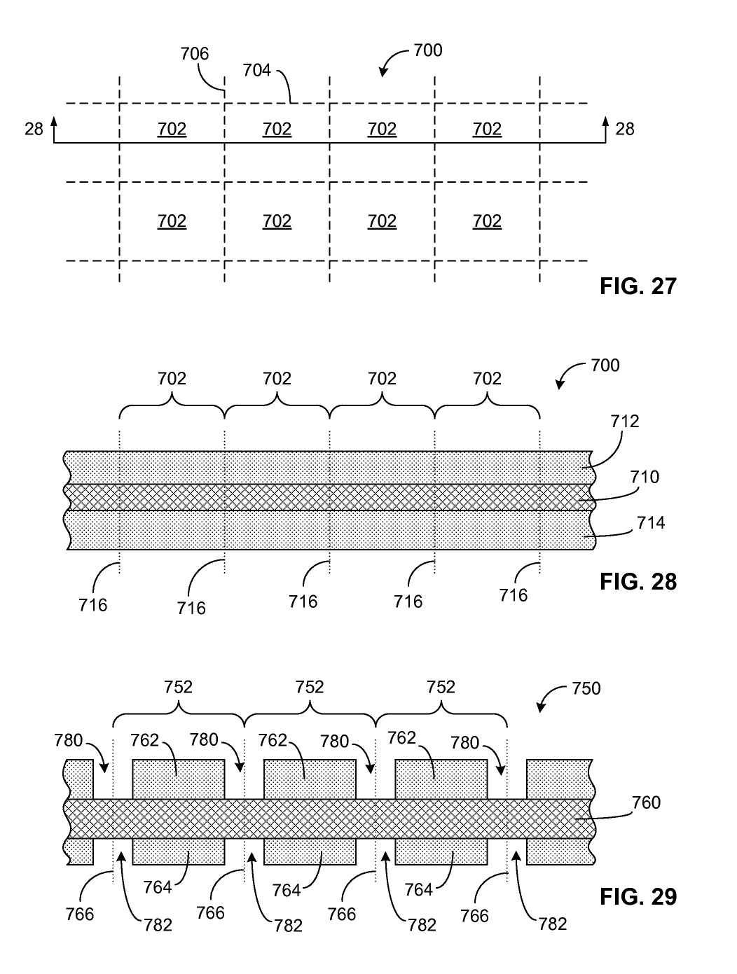

FIGS. 27 and 28 show an example configuration 700 where a stack of layers 714, 710, 712 defines an array of individual devices 702. FIG. 27 is a plan view, and FIG. 28 is a side sectional view along the indicated line. In FIG. 27, dashed lines 704, 706 generally delineate the devices 702, and indicate where cuts will be made to separate the devices 702 into individual pieces.

In FIG. 28, cut lines 716 are shown to extend through each of the layers 714, 710, 712, and can correspond to, for example, the delineation lines 706. As one can see in the example of FIG. 28, presence of the multiple layers 714, 710, 712 increases the overall thickness of materials that need to be cut. Cutting of such relatively thick layers (e.g., by sawing) can be challenging, and can result in formation of mechanical defects such as cracks along the cut edges.

FIG. 29 shows that in some embodiments, one or more layers in a stack can be dimensioned to reduce the amount of materials through which singulating cuts are made. In an example configuration 750, an array of structures 762 is shown to be positioned above a base layer 760. Similarly, an array of structures 764 is shown to be positioned below the base layer 760. Open spaces 780, 782 between respective neighboring structures 762, 764 can be dimensioned to allow cutting operations along cut lines indicated as 766. Examples of how the structures 762, 764 can be formed to yield the respective open spaces 780, 782 are described herein in greater detail. Accordingly, a plurality of devices 752 can be formed from such a stack of layers, while having reduced the amount of material to cut. Each device 752 resulting from cutting of such an array can have, for example, a singulated base layer 760 and structures 762, 764 above and below the singulated base layer 760.

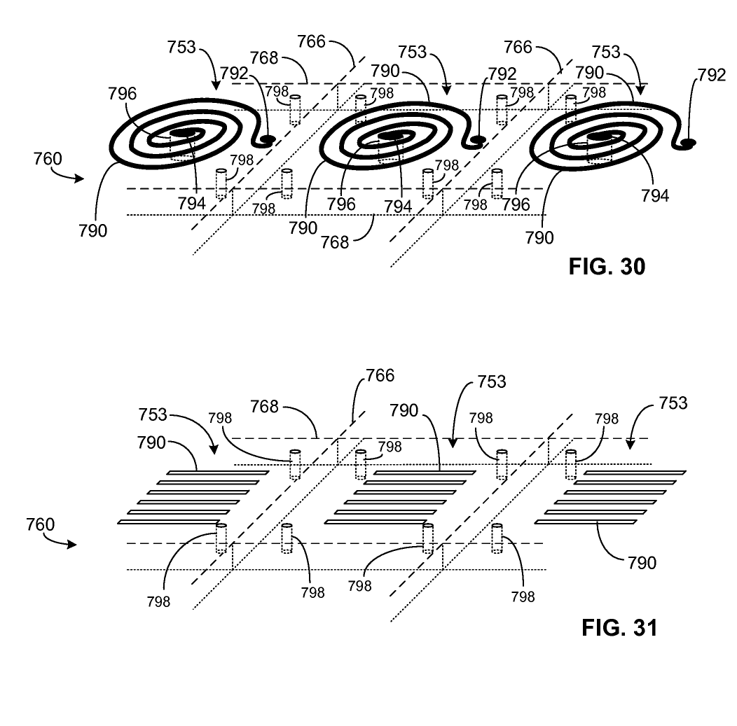

In some embodiments, the base layer 760 can be configured to include an array of functional electrical/magnetic elements (such as the examples of FIGS. 30 and 31), configured to provide structural support for such electrical/magnetic elements, configured to provide structural support for structures formed thereon without such electrical/magnetic elements, or any combination thereof. Such a base layer can be, for example, a polymeric laminate layer as described herein, and can include a layer formed from any material utilized for printed circuit boards (PCBs).

In some embodiments, the structures 762 can be configured to include one or more electrical/magnetic elements described herein (such as the example elements of FIGS. 30 and 31), configured to provide structural support and/or spacing functionality for such electrical/magnetic elements, configured to provide structural support and/or spacing functionality for additional layers formed thereon without such electrical/magnetic elements, or any combination thereof. Examples of materials that can be utilized to form such structures are described herein in greater detail.

Similarly, the structures 764 can be configured to include one or more electrical/magnetic elements described herein (such as the example elements of FIGS. 30 and 31), configured to provide structural support and/or spacing functionality for such electrical/magnetic elements, configured to provide structural support and/or spacing functionality for additional layers formed thereon without such electrical/magnetic elements, or any combination thereof. Examples of materials that can be utilized to form such structures are described herein in greater detail.

FIGS. 30 and 31 show non-limiting examples of a base layer 760 on which structures 762 and/or 764 of FIG. 29 can be implemented. In both examples, a plurality of units 753 can be delineated by the example cut lines 766, 768 in manners similar to the example of FIG. 29.

In the example of FIG. 30, each unit 753 of the base layer 760 is shown to include a spiral conductive ribbon 790 implemented on the upper surface. Such a spiral conductive ribbon can be implemented as described herein, including the use of copper foil, plating, etc. The lower surface of each unit 753 may or may not include a similar spiral conductive ribbon or another conductor feature.

In the example of FIG. 30, an outer end of the spiral conductive ribbon 790 is shown to be connected to a conductive feature 792 implemented to provide electrical connection to, for example, a terminal on the same side or the other side of the unit 753, to another surface of a structure formed thereon (e.g., structure 762 in FIG. 29), etc. Such an electrical connection can be facilitated by, for example, a metalized via or a plated castellation. Such a via or castellation can be formed in manners as described herein.

Also in the example of FIG. 30, an inner end of the spiral conductive ribbon 790 is shown to be connected to a via feature 794 implemented to provide electrical connection to, for example, a conductive feature on the other side of the unit 753, to a conductive feature on another surface of a structure formed thereon (e.g., structure 762 in FIG. 29), etc. Such an electrical connection can be facilitated by, for example, a metalized via 796 at or near the center of the spiral conductive ribbon pattern. In some embodiments, the via feature 794 can be formed to be an opening at or near the center of a resulting circular magnetic field, and the opening could be filled with a magnetic material to help direct the field to achieve desired magnetic properties. In other embodiments, one or more openings could be formed by, for example, punching, laser or mechanical drilling, and such opening(s) could be filled with a gas or a non-magnetic material to create gaps which can be utilized in the construction of magnetic devices such as transformers. Such devices can be configured to change the properties of the magnetic field to thereby achieve desired magnetic properties.

FIG. 30 shows that in some embodiments, one or more vias 798 can be formed for each unit 753 at selected locations. Such vias can be utilized as anchor vias to secure structures implemented above and/or below the unit 753. An example of such a mechanical anchoring configuration is described herein in greater detail.

In the example of FIG. 31, each unit 753 of the base layer 760 is shown to include a plurality of conductive strips 790 implemented on the upper surface. Such conductive strips can be implemented as described herein, including the use of copper foils, plating, etc. The lower surface of each unit 753 may or may not include similar conductive strips or other conductor feature(s).

In the example of FIG. 31, conductive features such as metalized traces and/or metalized vias associated with the conductive strips 790 that facilitate electrical contacts with other locations (e.g., the lower side) are not shown. However, such conductive features can be implemented in manners similar to those described herein.

FIG. 31 shows that in some embodiments, one or more vias 798 can be formed for each unit 753 at selected locations. Such vias can be utilized as anchor vias to secure structures implemented above and/or below the unit 753. An example of such a mechanical anchoring configuration is described herein in greater detail.

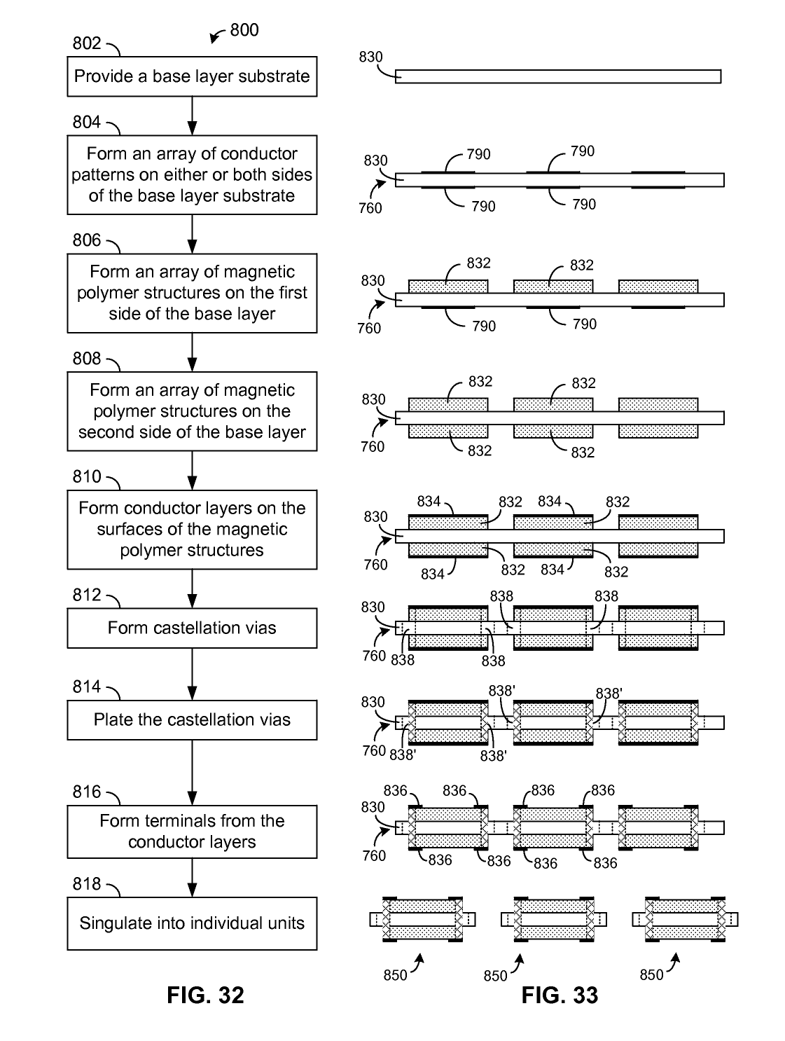

FIG. 32 shows an example process 800 that can be implemented to fabricate polymeric planar magnetic devices based on the base layer and structures described in reference to FIGS. 29-31. FIG. 33 shows examples of various stages of fabrication generally corresponding to various steps of the process 800.

In block 802, a base layer substrate can be provided. In FIG. 33, such a base layer substrate is depicted as 830. As described herein, the base layer substrate can be a polymeric laminate layer formed from, for example, any material utilized for printed circuit boards (PCBs). In some embodiments, the base layer substrate can be formed from or include polymeric magnetic materials. In some embodiments, the base layer substrate can be formed from or include combinations of polymeric laminate layers and polymeric magnetic materials. In some embodiments, the base layer substrate may or may not be electrically conductive.

In block 804, an array of conductor patterns can be formed on either or both sides of the base layer substrate to yield a base layer. In FIG. 33, such a base layer is depicted as 760 having conductor patterns 790 on both sides of the base layer substrate 830. It will be understood that such conductor patterns can be on either or both sides of the base layer substrate 830. As described herein, such conductor patterns can include, for example, a spiral pattern or a group of strips. In some embodiments, some or all of the conductor patterns can be laminated directly to the base layer substrate depicted as 830. In some embodiments, some or all of the conductor patterns can be laminated to the base layer substrate using one or more layers of interposing polymeric material such as, for example, pre-preg which is commonly utilized for the lamination of printed circuit board (PCB) layers. The interposing polymeric materials may or may not contain magnetic materials and may or may not be electrically conductive. The interposing polymeric material may or may not have high thermal conductivity. Although not shown in FIG. 33, through-layerthrough-layer vias can be formed for conductive plating to, for example, allow electrical connection of layers of the conductor patterns. Such through-layerthrough-layer vias can include the example center through-layerthrough-layer vias, plated and configured to connect the top and bottom spirals and/or strips (e.g., 796 in FIG. 30). Such through-layerthrough-layer vias can also be plated and configured to connect multiple spiral pairs together to increase the number of turns of the device and thus its inductance. The example center though hole vias (e.g., 794 in FIG. 30) can be formed to be an opening at or near the center of the circular magnetic field which could be filled with a magnetic material to help direct the field to achieve the desired magnetic properties. In another embodiment, one or more openings could be formed by, for example, punching, laser or mechanical drilling which could be filled with a gas or a non-magnetic material to create gaps which are often utilized in the construction of magnetic devices such as transformers, which can change the properties of the magnetic field to achieve the desired magnetic properties.

In block 806, an array of magnetic polymer structures can be implemented on the first side (e.g., upper side) of the base layer. In FIG. 33, such magnetic polymer structures are depicted as 832. In block 808, an array of magnetic polymer structures can be implemented on the second side (e.g., lower side) of the base layer. In FIG. 33, such magnetic polymer structures are depicted as 832.

In some embodiments, the magnetic polymer structures 832 on the upper and/or lower sides of the base layer 760 can be implemented in a number of ways. For example, magnetic polymer structures 832 can be formed on a surface of the base layer 760 by a screen printing process or a molding process utilizing magnetic polymer material. In another example, pre-formed magnetic polymer structures 832 can be mounted on a surface of the base layer 760 by, for example, adhesive and/or mechanical attachment devices. Examples of the foregoing implementations of magnetic polymer structures 832 are described herein in greater detail.

In block 810, conductor layers can be formed on the surfaces of the magnetic polymer structures 832. In FIG. 33, such conductor layers are depicted as 834.

In FIG. 32, blocks 812 and 814 are directed to an example packaging configuration that utilizes conductive castellation features. It will be understood that other packaging techniques can also be implemented.

In block 812, castellation vias can be formed at selected locations of the base layer 760. In FIG. 33, such vias are depicted as 838. In some embodiments, the vias 838 can also result in respective portions of the magnetic polymer structures 832 being removed to yield castellation features. In some embodiments, other types of castellations can be formed. For example, a larger hole formed (e.g., by drilling) on a location of an open space between two magnetic polymer structures 832 can be dimensioned to yield half-circle castellations on the base layer substrate 830; and such castellations can extend into the respective magnetic polymer structures 832. Although not shown in FIG. 33, vias can be formed and configured to provide, for example, mechanical connection functionality (e.g., 798 in FIG. 30) or magnetic connection of two or more polymeric magnetic layers.

In block 814, the castellation vias and exposed surfaces of the magnetic polymer structures 832 can be plated with metal. In FIG. 33, such plated vias are depicted as 838′. In block 816, the conductor layers formed in block 810 can be etched appropriately to form conductive paths and/or terminals. In FIG. 33, such terminals are depicted as 836. In some embodiments, formation of such terminals can be achieved by, for example, etching. In some embodiments, the terminals 836 on the magnetic polymer structures 832 can become electrically connected to their respective conductor patterns (e.g., 790 in FIG. 33) by conductive vias and/or conductive castellation features as described herein.

In block 818, the array formed in the foregoing manner can be singulated into individual units. In FIG. 33, such individual units are depicted as 850.

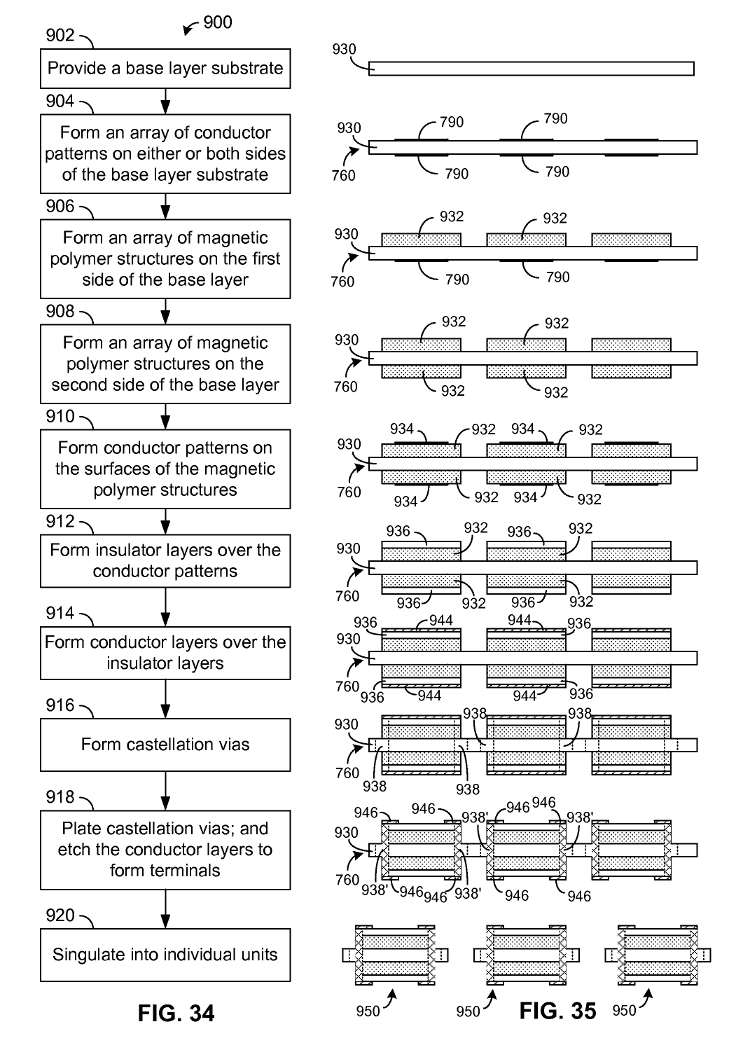

FIG. 34 shows another example process 900 that can be implemented to fabricate polymeric planar magnetic devices based on the base layer and structures described in reference to FIGS. 29-31. FIG. 35 shows examples of various stages of fabrication generally corresponding to various steps of the process 900.

In block 902, a base layer substrate can be provided. In FIG. 35, such a base layer substrate is depicted as 930. As described herein, the base layer substrate can be a polymeric laminate layer formed from, for example, any material utilized for printed circuit boards (PCBs). In some embodiments, the base layer substrate can be formed from or include polymeric magnetic materials. In some embodiments, the base layer substrate can be formed from or include combinations of polymeric laminate layers and polymeric magnetic materials. In some embodiments, the base layer substrate may or may not be electrically conductive.

In block 904, an array of conductor patterns can be formed on either or both sides of the base layer substrate to yield a base layer. In FIG. 35, such a base layer is depicted as 760 having conductor patterns 790 on both sides of the base layer substrate 930. It will be understood that such conductor patterns can be on either or both sides of the base layer substrate 930. As described herein, such conductor patterns can include, for example, a spiral pattern or a group of strips. In some embodiments, some or all of the conductor patterns can be laminated directly to the base layer substrate depicted as 930. In some embodiments, some or all of the conductor patterns can be laminated to the base layer substrate using one or more layers of interposing polymeric material such as, for example, pre-preg which is commonly utilized for the lamination of printed circuit board (PCB) layers. The interposing polymeric materials may or may not contain magnetic materials and may or may not be electrically conductive. The interposing polymeric material may or may not have high thermal conductivity. Although not shown in FIG. 35, through-layer vias can be formed for conductive plating to, for example, allow electrical connection of layers of the conductor patterns. Such through-layer vias can include the example center through-layer vias, plated and configured to connect the top and bottom spirals and/or strips (e.g., 796 in FIG. 30). Such through-layer vias can also be plated and configured to connect multiple spiral pairs together to increase the number of turns of the device and thus its inductance. The example center though hole vias (e.g., 794 in FIG. 30) can be formed to be an opening at or near the center of the circular magnetic field which could be filled with a magnetic material to help direct the field to achieve the desired magnetic properties. In another embodiment, one or more openings could be formed by, for example, punching, laser or mechanical drilling which could be filled with a gas or a non-magnetic material to create gaps which are often utilized in the construction of magnetic devices such as transformers, which can change the properties of the magnetic field to achieve the desired magnetic properties.

In block 906, an array of magnetic polymer structures can be implemented on the first side (e.g., upper side) of the base layer. In FIG. 35, such magnetic polymer structures are depicted as 932. In block 908, an array of magnetic polymer structures can be implemented on the second side (e.g., lower side) of the base layer. In FIG. 35, such magnetic polymer structures are depicted as 932.

In some embodiments, the magnetic polymer structures 932 on the upper and/or lower sides of the base layer 760 can be implemented in a number of ways. For example, magnetic polymer structures 932 can be formed on a surface of the base layer 760 by a screen printing process or a molding process utilizing magnetic polymer material. In another example, pre-formed magnetic polymer structures 932 can be mounted on a surface of the base layer 760 by, for example, adhesive and/or mechanical attachment devices. Examples of the foregoing implementations of magnetic polymer structures 932 are described herein in greater detail.

In block 910, conductor patterns can be implemented on the surfaces of the magnetic polymer structures 932. In FIG. 35, such conductor patterns are depicted as 934. In some embodiments, the conductor patterns 934 on the magnetic polymer structures 932 can be configured to provide stack functionality as described herein. Although not shown in FIG. 35, through-layer vias can be formed for conductive plating to, for example, allow electrical connection of layers of the conductor patterns. Such through-layer vias can be plated and configured to connect the top and bottom spirals and/or strips. Such through-layer vias can also be plated and configured to connect multiple spiral pairs together to increase the number of turns of the device and thus its inductance.

In block 912, insulator layers can optionally be formed over the conductive patterns. In FIG. 35, such insulator layers are depicted as 936. In some implementations, the insulator layers 936 can be formed by a screen printing process, by molding, by lamination of sheets of insulator material, by spraying the insulator material, by dipping the array of polymeric structures into liquid insulator material or by other methods commonly utilized in PCB manufacturing. Optionally, masking methods may be utilized to keep the insulating material out of the open spaces between the structures 932 to facilitate the subsequent sawing/singulation processes. Optionally, the insulator material may contain magnetic materials. Optionally, the insulator material may have high thermal conductivity. Optionally, additional conductor patterns 934′ may be formed on the insulator layers 936, which are formed on the magnetic polymer structures 932 located on one or both sides of base layer 760. Optionally, one or more additional insulator layers 936′ may be formed over the conductor patterns 934′. In some embodiments, alternating layers of such conductor patterns and insulator layers may be used to construct, or be configured as, more complex inductors, transformers, chokes, or other magnetic devices. Although not shown in FIG. 35, through-layer vias can be formed for conductive plating to, for example, allow electrical connection of layers of the conductor patterns. Such through-layer vias can be plated and configured to connect the top and bottom spirals and/or strips. Such through-layer vias can also be plated and configured to connect multiple spiral pairs together to increase the number of turns of the device and thus its inductance.

In FIG. 34, blocks 914, 916, and 918 are directed to an example packaging configuration that utilizes conductive castellation features. It will be understood that other packaging techniques can also be implemented.

In block 914, conductor layers can be formed over the insulation layers 936. In FIG. 35, such conductor layers are depicted as 944.

In block 916, castellation vias can be formed at selected locations of the base layer 760. In FIG. 35, such vias are depicted as 938. In some embodiments, the vias 938 can also result in respective portions of the magnetic polymer structures 932 and the insulator layers 936 being removed to yield castellation features. In some embodiments, other types of castellations can be formed. For example, a larger hole formed (e.g., by drilling) on a location of an open space between two magnetic polymer structures 932 can be dimensioned to yield half-circle castellations on the base layer substrate 930; and such castellations can extend into the respective magnetic polymer structures 932. Although not shown in FIG. 35, vias can be formed and configured to provide, for example, mechanical connection functionality (e.g., 798 in FIG. 30) or magnetic connection of two or more polymeric magnetic layers.

In block 918, the castellation vias and exposed surfaces of the magnetic polymer structures 932 and the optional insulator layers 936 can be plated with metal, and etched appropriately to form conductive paths and/or terminals. In FIG. 35, such plated castellation vias are depicted as 938′, and the terminals are depicted as 946.

In block 920, the array formed in the foregoing manner can be singulated into individual units. In FIG. 35, such individual units are depicted as 950.

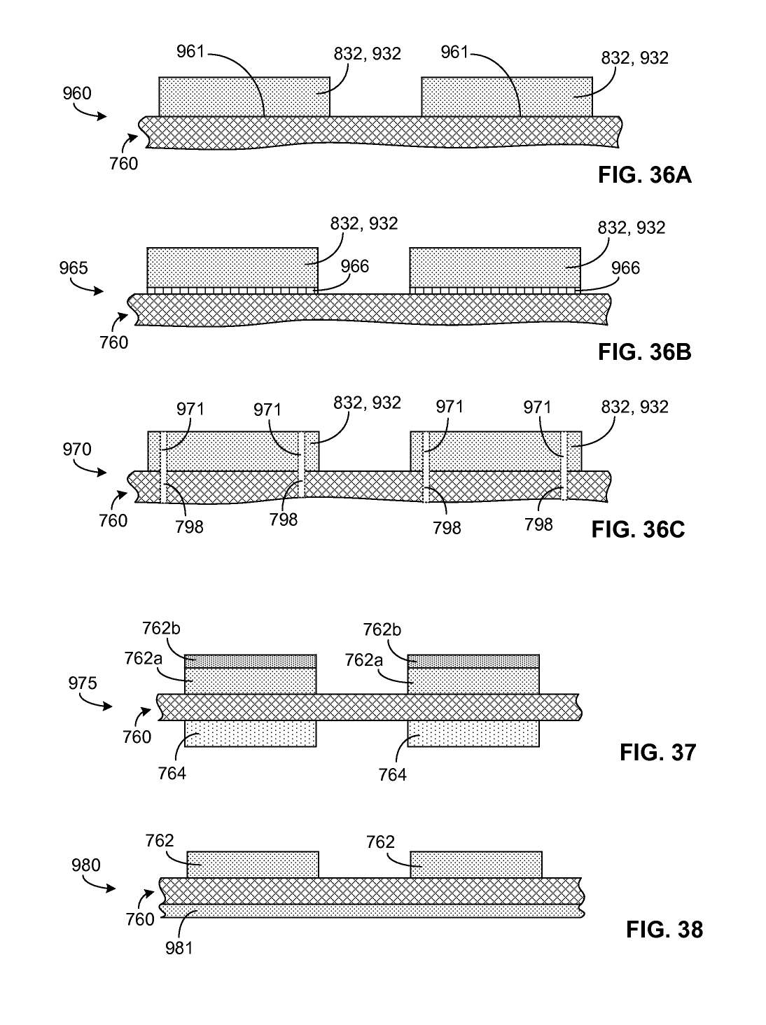

FIGS. 36A-36C show non-limiting examples of how magnetic polymer structures (e.g., 832 of FIG. 33 or 932 of FIG. 35) can be implemented on a base layer 760. FIG. 36A shows an example configuration 960 where a plurality of magnetic polymer structures 832, 932 can be formed on a surface of a base layer 760. Such formation of magnetic polymer structures 832, 932 can be implemented by, for example, screen printing or molding of magnetic polymer material. In such a configuration, an interface 961 between the formed magnetic polymer structure 832, 932 and the surface of the base layer 760 can provide sufficient adhesion.

In some embodiments, it may be desirable to mount pre-fabricated magnetic polymer structures on a base layer. FIG. 36B shows an example configuration 965 where a plurality of magnetic polymer structures 832, 932 can be mounted on a surface of a base layer 760. Such mounting of magnetic polymer structures 832, 932 can be facilitated by, for example, an adhesive layer 966. The adhesive layer 966 may or may not contain magnetic materials. The adhesive layer 966 may or may not have high thermal conductivity.

FIG. 36C shows another example configuration 970 where a plurality of magnetic polymer structures 832, 932 can be mounted on a base layer 760. In such an example, a plurality of anchor vias (vias 971 in the magnetic polymer structures 832, 932, and matching vias 798 in the base layer 760) can be formed to facilitate mechanical fastening of the magnetic polymer structures 832, 932 to the base layer 760. For example, appropriately sized pins can be driven into the vias 971, 798 to in the magnetic polymer structures 832, 932 on the base layer 760.

FIGS. 37 and 38 show some design variations that can be implemented based on one or more features as described herein. FIG. 37 shows that in some embodiments, more than one layer of structures can be formed or provided on a base layer. In an example configuration 975, two layers of structures 762a, 762b are shown to be implemented on a base layer 760. Such layers can include magnetic polymer/conductive pattern structures, non-magnetic spacer structures, insulator structures, thermal conductor structures, or some combination thereof. In the example of FIG. 37, one layer of structures 764 is shown to be formed or provided on the lower side of the base layer 760. It will be understood that the lower side can include less or more number of structure-layers.

In the various examples described in reference to FIGS. 29-37, it is generally assumed that open spaces defined by an array of structures allow an underlying base layer to be cut in a more efficient manner. In some situations, however, it may be desirable to have an additional layer accompany and be cut with the base layer. If the overall thickness of the base layer and the additional layer is sufficiently small, and/or if the additional layer is made of material that does not provide much resistance or challenges to cutting operations, such a configuration can provide similar advantageous features.

In an example configuration 980 of FIG. 38, an additional layer 981 is shown to be implemented on a lower side of a base layer 760. Implemented on an upper side of the base layer 760 is a layer of structures 762, with open spaces between the structures 762. Accordingly, when cutting operations are performed between the structures 762, the base layer 760 and the additional layer 981 can be cut together. In some implementations, the additional layer 981 can be made from material(s) similar to base layers as described herein, structures as described herein (e.g., magnetic polymer/conductive pattern structures, non-magnetic spacer structures, insulator structures, or thermal conductor structures), or any combination thereof.

In some embodiments, one or more features of the present disclosure can include, facilitate and/or yield very low profile magnetic surface-mountable devices. Some or all of such devices can include and/or benefit from use of a combination of polymeric magnetic materials and conductors such as foil/plated up conductors, together with PCB processing (e.g., lamination, drilling, plating, photolithography, etching), screen printing and/or molding. In some embodiments, conductive ribbons and vias can be formed on the polymeric magnetic materials, with or without prepreg layers between the conductor ribbons and the polymeric magnetic materials. In some embodiments, the foregoing plated up conductors can be obtained by a selective plating up process as described herein, where a plurality of plating cycles can be performed to build up the thickness of the plating to a desired configuration. For example, such plating cycle can include a photolithography step associated with masking followed by plating and selective etching or photo mask removal operation.

In some embodiments, one or more features of the present disclosure can provide an ability to form arrays and stacks of multiple components in, for example, a single surface-mountable device. In some embodiments, one or more features of the present disclosure can provide an ability to combine other electronic devices in the same package as one or more polymeric magnetic devices. In some embodiments, one or more features of the present disclosure can provide an option of forming pairs of surface mountable terminals on one or both sides of polymeric magnetic devices. In some implementations, one or more features of the present disclosure can allow production and testing of a plurality of polymeric magnetic devices in arrays to, for example, reduce cost and improve quality.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A magnetic device comprising:
a polymeric laminate layer having a first side and a second side opposite the first side;
a first set of one or more conductive ribbons disposed on the first side of the polymeric laminate layer;
a second set of one or more conductive ribbons disposed on the second side of the polymeric laminate layer; and
a set of one or more conductive vias that extend through the polymeric laminate layer to electrically connect the first set of conductive ribbons and the second set of conductive ribbons to thereby yield a winding.

2. (canceled)

3. The device of claim 1, wherein each of the first and second sets of conductive ribbons includes a plurality of strip ribbons arranged in a generally parallel manner so as to yield a magnetic flux axis that is generally parallel to a plane of the polymeric laminate layer when a current flows through the winding.

4. The device of claim 1, wherein each of the first and second sets of conductive ribbons includes a spiral shaped ribbon, the first and second spiral shaped ribbons electrically connected so as to yield a magnetic flux axis that is generally perpendicular to a plane of the polymeric laminate layer when a current flows through the winding.

5. The device of claim 1, wherein the polymeric laminate layer includes a magnetic material configured to provide a magnetic core for the winding.

6. The device of claim 5, wherein the winding includes an input terminal and an output terminal so as to yield a planar inductor having an inductance value.

7. The device of claim 5, further comprising a second winding, the first and second windings configured and positioned relative to each other.

8. The device of claim 7, wherein the first and second windings are formed on a common polymeric laminate layer.

9. The device of claim 7, wherein the first and second windings are formed on separate polymeric laminate layers.

10. The device of claim 9, wherein the polymeric laminate layers associated with the first and second windings are arranged in a stack.

11. The device of claim 9, wherein the first and second windings are arranged in a nested configuration.

12. (canceled)

13. The device of claim 7, wherein the first winding and the second winding are configured and positioned relative to each other so as to yield a transformer.

14. The device of claim 7, wherein first and second magnetic flux axes associated with the first and second windings are generally co-planar.

15. (canceled)

16. (canceled)

17. The device of claim 5, further comprising one or more packaging layers disposed on one or more of the first and second sides of the polymeric laminate layer.

18. The device of claim 17, wherein the packaging layer includes one or more electrical terminals connected to one or more terminals of the winding.

19. The device of claim 17, wherein the packaging layer is configured to provide magnetic shielding.

20. A method for manufacturing magnetic devices, the method comprising:
forming or providing a polymeric laminate layer having a first side and a second side opposite the first side, the polymeric laminate layer including a plurality of regions, each region configured to be separable into an individual unit;
forming a first set of one or more conductive ribbons on the first side of each region of the polymeric laminate layer;
forming a second set of one or more conductive ribbons on the second side of each region of the polymeric laminate layer; and
forming a set of one or more conductive vias through each region of the polymeric laminate layer to electrically connect the first set of conductive ribbons and the second set of conductive ribbons to thereby yield a winding for each region.

21. The method of claim 20, further comprising forming a second winding that includes third and fourth sets of one or more conductive ribbons on the first and second sides, respectively, of each region of the polymeric laminate layer.

22. The method of claim 20, further comprising forming a plurality of terminals for the winding of each region.

23. The method of claim 22, further comprising performing one or more tests by making electrical contact with the terminals of the winding while the polymeric laminate layer remains un-singulated.

24. The method of claim 22, further comprising singulating the polymeric laminate layer so as to yield a plurality of individual magnetic devices corresponding to the plurality of regions.

25. (canceled)

26. The method of claim 22, further comprising coupling a non-magnetic device to each of the un-singulated individual unit.

27. A surface-mountable magnetic device comprising:
a first planar component including a polymeric laminate layer having a first side and a second side, the first planar component further including one or more conductive patterns implemented on either or both of the first and second sides of the polymeric laminate layer so as to provide planar magnetic functionality;
a second planar component coupled to the first side of the first planar component;
a plurality of terminals implemented on either or both of the first and second planar components, the terminals configured to allow surface-mounting of the magnetic device; and
a plurality of connection features implemented to provide electrical connections between the one or more conductive patterns of the first planar component and the plurality of terminals.

28. The device of claim 27, wherein the polymeric laminate layer of the first planar component includes a magnetic material configured to provide a magnetic core.

29. The device of claim 27, wherein at least some of the terminals are on the second planar component.

30. The device of claim 29, further comprising a third planar component coupled to the second side of the first planar component.

31. The device of claim 30, wherein at least some of the terminals are on the third planar component.

32. The device of claim 30, wherein the polymeric laminate layer of the first planar component includes a perimeter having at least one cut edge resulting from a singulation process that yields the surface-mountable magnetic device as one of a plurality of similar devices.

33. The device of claim 32, wherein at least one of the second and third planar components includes a planar structure formed from a magnetic polymer material.

34. The device of claim 33, wherein at least one of the second and third planar components includes a perimeter that includes an edge set inward from the cut edge of the polymeric laminate layer of the first planar component by an amount sufficient to allow a cutting operation that cuts the polymeric laminate layer.

35. (canceled)

36. The device of claim 34, wherein the terminals on at least one side of the magnetic device are patterned from a conductive layer formed on an outer surface of the planar structure.

37. The device of claim 34, wherein at least one of the second planar component and the third planar component further includes a conductor pattern formed on an outer surface of the planar structure.

38. The device of claim 37, wherein at least one of the second planar component and the third planar component further includes an insulator layer that substantially covers the conductor pattern formed on the outer surface of the planar structure.

39. The device of claim 38, wherein at least some of the terminals are patterned from a conductive layer formed on an outer surface of the insulator layer.

40. (canceled)

41. The device of claim 39, wherein the plurality of connection features includes one or more conductive vias.

42. The device of claim 41, wherein the one or more conductive vias includes at least one metal plated castellation via.

43-75. (canceled)
